(19) United States
(12) Patent Application Publication
(10) Pub. No.: US 2016/0227774 A1
(43) Pub. Date: Aug. 11, 2016

(54) PLANT DEFENSE INDUCER COMPOUNDS FOR CITRUS HUANGLONGBING

(71) Applicant: University of Florida Research Foundation, Inc., Gainesville, FL (US)

(72) Inventors: Nian WANG, Auburndale, FL (US); Jinyun LI, Winter Haven, FL (US); Jiahuai HU, Lake Alfred, FL (US)

(21) Appl. No.: 15/018,803

(22) Filed: Feb. 8, 2016

Related U.S. Application Data
(60) Provisional application No. 62/113,068, filed on Feb. 6, 2015.

(51) Int. Cl. A01N 43/16; A01N 37/46

(52) U.S. Cl. CPC A01N 43/16; A01N 37/46

(57) ABSTRACT

A method and compounds are described and claimed relating to plant defense inducer compositions and compounds, and to their use for improving certain aspects of plant and crop management, including treating plant disease, improving the ability of plants to defend against disease, reducing disease symptoms, treating HLB disease, minimizing crop yield decreases due to plant disease, improving crop productivity, and increasing crop quality. In particular, the compounds and compositions are useful for controlling and treating plant disease, for example Huanglongbing disease (HLB) and mitigating disease symptoms of HLB and Ca. Liberibacter infection in plants. Crop plants are contemplated for use with the invention, for example citrus trees. Methods according to embodiments of the invention involve treatment of affected plants by application (preferably by injection into the trunk, soil application or foliar spraying) of one or more compounds selected from β-aminobutyric acid or a salt thereof, 2-deoxy-D-glucose, salicylic acid or a salt thereof, oxalic acid. Typical methods involve application of a composition containing a botanically acceptable vehicle and β-aminobutyric acid. In certain methods, the plants used in the method are citrus plants, and the citrus plants are affected by or susceptible to Huanglongbing (HLB) disease or infection by Candidatus Liberibacter species.

### STATEMENT OF GOVERNMENTAL INTEREST

This invention was made with government support under Contract No. CRDF 00101256. The government has certain rights in the invention.

### BACKGROUND

1. Field of the Invention

The present invention relates to plant defense inducer compositions and compounds, and to their use for improving certain aspects of plant and crop management, including treating plant disease, improving the ability of plants to defend against disease, reducing disease symptoms, treating HLB disease, minimizing crop yield decreases due to plant disease, improving crop productivity, and increasing crop quality. In particular, the compounds and compositions are useful for controlling and treating plant disease, for example Huanglongbing disease (HLB) and mitigating disease symptoms of HLB and Ca. Liberibacter infection in plants. Crop plants are contemplated for use with the invention, for example citrus trees.

2. Description of the Related Art

Conventional pest control technologies based on the use of agricultural chemicals have contributed to efficient agricultural productivity. However, they have led to public concerns on environmental issues. Environmentally-sound agriculture using no or reduced amounts of agricultural chemicals and satisfying cultivation efficiency and assuring safety is desired. Therefore, pest and disease control technology fulfilling such demand is necessary.

Crops in different ecosystems around the world may suffer less than ideal conditions due to soil or weather conditions, or various stresses, as well as diseases that can negatively affect the health and vigor of the crop plants. Such factors can reduce productivity of the crops to a greater or lesser degree, even under good growing conditions. Thus, crop plants can benefit from treatment that will increase the health and vigor of the plants or improve crop production, whether the plants are stressed by poor conditions, by disease, or even when the plants are healthy or grown under favorable conditions.

A number of plant diseases have negative effects on crop plants worldwide. Microbial plant pathogens can lead to losses in yield, and can even kill the crop plants. Strategies to improve plant defenses against pathogens are therefore needed to improve cultivation, crop yield, and crop quality, which preferably are strategies that avoid environmental pollution of the plants and the soil in which they are grown. Biological approaches, such as the use of plant defense inducer compounds as described herein, are therefore helpful with improving crop plant health generally, and reducing the negative effects of plant pathogens, particularly in citrus.

An example of a harmful plant disease in citrus is HLB or citrus greening disease, which is also referred to as yellow shoot or yellow dragon. This is a major bacterial disease of citrus crops and can be found in Asia, in the Americas and in Africa. It has been spreading worldwide, resulting in economic loss. HLB is currently the most economically devastating disease of citrus worldwide and no established cure is available. All commercial citrus varieties currently available are susceptible to HLB and the citrus industries in affected areas have suffered a decline in both production and profit (Bové, 2006; Gottwald et al., 2007; Wang and Trivedi, 2013).

HLB was identified in Brazil in 2004 (Gottwald et al., 2007). In the United States, since first identified in Florida in 2005 (Sutton et al., 2005), HLB has expanded to Louisiana, South Carolina, Georgia, Texas and California (Wang and Trivedi, 2013). It has also been discovered in Cuba, Belize, Jamaica, Mexico, and other countries in the Caribbean (Wang and Trivedi, 2013). All commercial citrus varieties currently available are susceptible to HLB and the citrus industries in affected areas have suffered a decline in both production and profit (Bové, 2006; Gottwald et al., 2007; Wang and Trivedi, 2013). In Florida, HLB is now present in all commercial citrus-producing counties and is destroying the $9 billion citrus industry at a rapid pace. It was estimated that HLB has played a key role in the loss of about 100,000 citrus acres since 2007 in Florida and has cost Florida's economy approximately $3.6 billion in lost revenues since 2006 (Gottwald, 2010; Wang and Trivedi, 2013).

Citrus HLB is associated with a phloem-limited fastidious α-proteobacterium belonging to the ‘Candidatus’ genus Liberibacter, formerly known as Liberobacter (Jagoueix et al., 1994). Currently, three species of ‘Ca. Liberibacter’ have been identified to cause HLB disease: ‘Ca. L. asiaticus’ (Las), ‘Ca. L. africanus’, and ‘Ca. L. americanus’ (Gottwald, 2010). These bacteria have not been cultivated in pure culture. HLB pathogen is mainly spread by an insect vector, a type of psyllid, in the field. There are two psyllid species transmitting Liberibacters: Asian citrus psyllid (Diaphorina citri) in Asia and the Americas (Bové, 2006; Halbert, 2005; Teixeira et al., 2005) and African citrus psyllid (Trioza erytreae) in Africa (Bové, 2006). Las and Asian citrus psyllid are the most prevalent and important throughout HLB-affected citrus-growing areas worldwide (Bové, 2006). Las propagates in the phloem of the host plants, resulting in die-back, small leaves, yellow shoots, blotchy mottles on leaves, corky veins, malformed and discolored fruit, aborted seed, premature fruit drop, root loss, and eventually tree death (Bové, 2006; Gottwald et al., 2007; Wang and Trivedi, 2013). The life span for the profitable productivity of infected citrus trees is dramatically shortened as the disease severity increases and the yield is significantly reduced (Gottwald et al., 2007). The understanding of virulence mechanism of the bacterial pathogen is limited, due to the difficulty in culturing Las. So far, most molecular insights of the HLB biology and Las pathogenicity are derived from the genome sequences of Las and other related Liberibacters (Duan et al., 2009; Lin et al., 2011; Leonard et al., 2012; Wulff et al., 2014).

The bacterium believed to be responsible for the disease in Florida is Ca. Liberibacter asiaticus (Las). Particularly sensitive citrus includes Citrus halimii, Nules' clementine mandarin, Valencia sweet orange, ‘Madam Vinous’ sweet orange, ‘Duncan’ grapefruit, ‘Ruby’ red grapefruit, and ‘Minneola’ tangelo, however, any citrus species is vulnerable to HLB. In addition, some related plants in the genus Rutaceae, and other plants may become infected with Ca. Liberibacter species. Those of skill in the art are able to test for infection by Ca. Liberibacter, and therefore are able to determine which plants suffer from HLB or Ca. Liberibacter infection. Treatment of such plants is considered part of this invention.

The symptoms of HLB differ according to the plant variety affected, and can include yellow shoots and mottling of the plant leaves, occasionally with thickening of the leaves, or other symptoms. The fruit of diseased trees generally is reduced in size, is green, may prematurely drop from the plant, and have a low soluble acid content or a bitter or salty taste. HLB also can result in the stunting or even death of the plant. Consequently, this disease is having major negative economic impact on citrus growers. HLB has affected major citrus-growing areas in Asia, the United States, and worldwide, resulting in lost citrus production and jobs in the citrus industry.

Current methods in use for HLB control include the use of HLB-free citrus seedlings, destruction of infected trees, and application of insecticides such as aldicarb (Temik®) or imidacloprid (Admire®). These insecticides are aimed at controlling psyllids, a possible insect vector for the disease, although it is not known if insecticides have a direct effect on the spread of HLB. These insecticide treatments do not reduce disease in trees already infected, in any case.

An integrated control program has been recommended for HLB in commercial orchards by the United Nations Development Program, Food and Agriculture Organization (UNDP, FAO) Southeastern Asian citrus rehabilitation project (Aubert, 1990). The program highlights controlling psyllid vectors with insecticides, reducing inoculum through removal of HLB-symptomatic trees, propagating and using pathogen-free budwood and nursery trees. In Florida, foliar nutrition programs coupled with vector (psyllid) control are often used to slow down the spread of HLB and reduce the devastating effects of the disease (Gottwald, 2010). These control practices have showed limited effect for preventing further spread of HLB. Post-harvest spraying of grapefruit with BABA has been attempted by Porat et al., 2003, however application to the plant pre-harvest was not taught.

Recently, various treatment strategies including applications of penicillin and streptomycin (Zhang et al., 2011), an enhanced nutrient program (Gottwald et al., 2012), thermotherapy (Hoffman et al, 2013), soil-conditioners (Xu et al., 2013), and small molecules targeting Las virulence traits including osmotic stress tolerance (Pagliai et al., 2014), have been examined for HLB disease management and some have shown progress. However, no effective approach has been established to control HLB and stop it from spreading to new citrus-production areas. Other than the destruction and removal of diseased trees, there is no effective control for HLB in infected trees, and there is no known cure for HLB. New and improved treatments for citrus (and other) HLB disease therefore are needed in the art.

Other plant pathogens of interest include the bacterium Xanthomonas citri causing citrus canker, Xanthomonas axonopodis pv. citrumelo causing citrus bacterial spot disease, and Xylella fastidiosa causing citrus variegated chlorosis; the pathogenic fungus Alternaria citri causing leaf and stem rot and spot, Phytophthora spp. causing foot and root rot, and Guignardia citricarpa causing citrus black spot, all of which can result in crop loss.

Induced resistance can confer long-lasting protection against a broad spectrum of plant diseases either locally or systemically (Durrant and Dong, 2004; Walters et al., 2013). Plant defense mechanisms can be activated by pathogens (Durrant and Dong, 2004), beneficial microorganisms (Weller et al., 2012; Zamioudis and Pieterse, 2012), or by chemical inducers (Walters et al., 2013). Overall, maximizing crop plant health and vigor has been a difficult problem with no comprehensive solution. Therefore, the embodiments of the invention described herein are provided for control of crop pathogens such as HLB, Xanthomonas citri causing citrus canker, Xanthomonas axonopodis pv. citrumelo causing citrus bacterial spot disease, and Xylella fastidiosa causing citrus variegated chlorosis; the pathogenic fungus Alternaria citri causing leaf and stem rot and spot, Phytophthora spp. causing foot and root rot, and Guignardia citricarpa causing citrus black spot and to improve plant health and vigor, including germination, growth, disease resistance, and improvement to crop quality and quantity.

### SUMMARY OF THE INVENTION

Techniques are provided for improving the health and disease resistance of plants, including important crop plants such as citrus. The methods also provide treatment and control of plant diseases in plants affected or susceptible to the disease. The plant defense inducer compounds according to embodiments of the invention described here can be applied to plants to treat a plant disease, such as HLB, improve resistance to disease, improve the ability to defend against disease, reduce disease symptoms, minimize decreases in crop yield due to a plant disease, improve crop productivity and crop quality in citrus, and increase juice content and juice quality in citrus. Therefore, the plant defense inducer compounds can be used to benefit healthy plants and diseased plants. The methods described herein involve application of the plant defense inducer compounds to the plant, including application to the soil around the plant by injection or soil drench methods, application to the surface of the plant, such as by spraying onto the plant or parts of the plant, such as by foliar spraying, or injection into the plant such as by trunk injection. Plants for which the invention is contemplated include any plant, particularly crop plants, but including ornamental plants as well. Citrus plants are most highly preferred.

Preferred methods according to embodiments of the invention relate to treating HLB in affected trees or other plants susceptible to this disease. Susceptible plants include any citrus species, or any plant which can become infected by Ca. Liberibacter. The invention is contemplated to include compositions, compounds and methods as described and exemplified herein for use in any citrus plant and in any plant infected with Ca. Liberibacter.

The plant defense inducer compounds contemplated for use with the present invention include β-aminobutyric acid (BABA; D,L-2-aminobutyric acid) and salts thereof, 2-deoxy-D-glucose (2-DDG), salicylic acid (SA) and salts thereof such as salicylic acid sodium salt, oxalic acid (OA) and salts thereof, or any combinations thereof. These compounds may be formulated in any suitable vehicle for application to the plant to be treated. For example, it may be convenient to dissolve the chemical in water or in an alcoholic solution, which is then diluted with water for application to the plant. Spraying the affected plant or trunk injection into the plant are specifically contemplated; however, any application method known in the art can be used, e.g., chemigation, soil injection, and soil drench.

Still other aspects, features, and advantages are readily apparent from the following detailed description, simply by illustrating a number of particular embodiments and implementations, including the best mode contemplated for carrying out the invention. Other embodiments also are capable of other and different features and advantages, and its several details can be modified in various obvious respects, all without departing from the spirit and scope of the invention. Accordingly, the drawings and description are to be regarded as illustrative in nature, and not as restrictive.

The purpose of the studies described herein was to evaluate the effects of various chemical inducer treatments on disease progression (for example HLB progression) and crop production under field conditions in order to determine the feasibility of using these treatments, and of using plant defense inducers generally, as a method for the control and management of crop plant populations. The induced defense reactions have exhibited positive influence in slowing down HLB disease progress and sustaining fruit productivity, which validated the potential of pursuing chemical plant defense inducers for management of plant diseases such as citrus HLB.

Therefore, embodiments of the invention include a method of treating a plant disease in a citrus plant in need thereof comprising administering to the citrus plant a composition which comprises a botanically compatible vehicle and at least one compound selected from the group consisting of β-aminobutyric acid (BABA) or a salt thereof; 2-deoxy-D-glucose (2-DDG) or a salt thereof; salicylic acid (SA) or a salt thereof; oxalic acid (OA) or a salt thereof; and any combination thereof. Certain preferred embodiments use the compound BABA, which advantageously can be administered in concentrations ranging from 15 μM to 1000 mM, preferably at concentrations of 15 μM, 50 μM, 100 μM, 150 μM, 200 μM, 500 μM, 750 μM or 1 mM, and more preferably at concentrations of 15 μM, 150 μM, 200 μM or 1 mM. Additional preferred embodiments use the compound is 2-DDG, which advantageously can be administered in concentrations of 10 μM to 100 μM, preferably at a concentration of 100 μM.

Methods according to embodiments of the invention are wherein the administering to the plant is by soil injection, soil drenching, or foliar spraying where the compound is BABA or 2-DDG. Additional methods according to the invention are wherein the administering to the plant is by trunk injection when the compound is BABA, SA or OA.

Methods according to embodiments of the invention involve treating when the plant disease is a bacterial disease or a fungal disease, preferably wherein the plant disease is HLB disease or wherein the plant is infected with HLB disease or has symptoms of HLB disease. In particular, embodiments involve treating when the plant is infected with a Candidatus Liberibacter species, such as, for example, wherein the Candidatus Liberibacter species is selected from the group consisting of Candidatus Liberibacter asiaticus, Candidatus Liberibacter americanus, Candidatus Liberibacter africanus, and any combination thereof.

Plants contemplated for the embodiments of the invention include members of the family Rutaceae, preferably members of the genus Citrus. Citrus plants can be selected from the group consisting of Citrus maxima (Pomelo); Citrus medica (Citron); Citrus micrantha (Papeda); Citrus reticulata (Mandarin orange); Citrus trifolata (trifoliate orange); Citrus japonica (kumquat); Citrus australasica (Australian Finger Lime); Citrus australis (Australian Round lime); Citrus glauca (Australian Desert Lime); Citrus garrawayae (Mount White Lime); Citrus gracilis (Kakadu Lime or Humpty Doo Lime); Citrus inodora (Russel River Lime); Citrus warburgiana (New Guinea Wild Lime); Citrus wintersii (Brown River Finger Lime); Citrus halimii (limau kadangsa, limau kedut kera) Citrus indica (Indian wild orange); Citrus macroptera; Citrus latipes; Citrus×aurantiifolia (Key lime); Citrus×aurantium (Bitter orange); Citrus×latifolia (Persian lime); Citrus×limon (Lemon); Citrus×limonia (Rangpur); Citrus×paradisi (Grapefruit), Citrus×sinensis (Sweet orange); Citrus×tangerina (Tangerine); Poncirus trifoliata×C. sinensis (Carrizo citrange), C. paradisi “Duncan” grapefruit×Pondirus trifoliate (Swingle citrumelo), Imperial lemon; tangelo; orangelo; tangor; kinnow; kiyomi; Minneola tangelo; oroblanco; sweet orange; ugli; Buddha's hand; citron; lemon; orange; bergamot orange; bitter orange; blood orange; calamondin; clementine; grapefruit; Meyer lemon; Rangpur; tangerine; and yuzu.

Additional methods according to embodiments of the invention include a method of treating a plant disease in a citrus plant in need thereof comprising administering to the citrus plant by trunk injection a composition which comprises a botanically compatible vehicle and at least one compound selected from the group consisting of salicylic acid (SA) or a salt thereof; and oxalic acid (OA) or a salt thereof. The compound can be SA or OA. Further embodiments of the invention include a method for improving resistance to disease, improving the ability to defend against disease, and reducing disease symptoms, in a citrus plant in need thereof, comprising administering to the citrus plant a composition which comprises a botanically compatible vehicle and at least one compound selected from the group consisting of β-aminobutyric acid (BABA) or a salt thereof and 2-deoxy-D-glucose (2-DDG) or a salt thereof. These methods can involve administering to the plant by soil drench or soil injection or by foliar spraying.

An additional preferred embodiment of the invention is a method of treating Huanglongbing disease in a citrus plant in need thereof, comprising administering to the citrus plant a composition which comprises a botanically compatible vehicle and a compound selected from the group consisting of β-aminobutyric acid (BABA) or a salt thereof; salicylic acid (SA) or a salt thereof; 2-deoxy-D-glucose (2-DDG) or a salt thereof; oxalic acid (OA) or a salt thereof; and any combination thereof. In some embodiments, the citrus is not grapefruit when the method of administering BABA is by post-harvest spraying of the fruit.

An additional preferred embodiment of the invention is a method of minimizing decrease in crop yield due to a plant disease in a citrus plant population, which method comprises administering to the plants of the population a composition which comprises a botanically compatible vehicle and at least one compound selected from the group consisting of β-aminobutyric acid (BABA) or a salt thereof; and 2-deoxy-D-glucose (2-DDG) or a salt thereof. These methods can involve administering to the plant by soil drench or soil injection, or by foliar spraying.

Additional preferred embodiments of the invention are a method for improving crop productivity and crop quality of a citrus plant, comprising administering to the citrus plant a composition which comprises a botanically compatible vehicle and β-aminobutyric acid (BABA) or a salt thereof; and a method for increasing juice content and increasing the brix:acid ratio of the juice of a citrus plant, comprising administering to the citrus plant a composition which comprises a botanically compatible vehicle and β-aminobutyric acid (BABA) or a salt thereof.

### BRIEF DESCRIPTION OF THE DRAWINGS

Certain embodiments are illustrated by way of example, and not by way of limitation, in the figures of the accompanying drawings.

FIG. 1A, FIG. 1B and FIG. 1C are graphs showing HLB disease progress on Midsweet orange trees in the MidFlorida area. Treatment 11 (T11; non-treated control with conventional citrus fertilization, pest and weed control, without plant defense inducer) was repeated in each panel to facilitate treatment comparison. Treatments 1-10 (T1-T10) were as indicated in Example 3. N=55 plants, with 5 replicates for each treatment. See Example 2-3. The average disease severity scores were calculated from evaluations of the treated trees. Bars represent standard errors of the mean values.

FIG. 2 provides data regarding the severity of HLB disease in plants, expressed as the standardized area under the disease progress stairs (sAUDPS) with Midsweet orange in the MidFlorida area, over time. Bars represent standard errors of the mean values. Asterisks indicate a significant difference (P<0.05) between the treatment and non-treated control based on Student's t-test. See Example 3.

FIG. 3 provides data regarding the relative expression of the β-1,3-glucanase gene (PR-2) in Midsweet orange leaves after a single application of different plant defense inducer compounds. Plants were treated with AA (60 μM), BABA (150 μM) and INA (0.1 mM) respectively. See Example 3. The relative expression change (Treatment vs Control) was calculated using the 2^{-ΔΔCt} method. Values represent the mean of three biological replicates and each sample consisted of combined four leaves from one plant (a total of three plants were assayed per treatment). Bars represent standard error. Asterisks indicate a significant difference (P<0.05) between the treatment and non-treated control based on Student's t-test. DAT=Day after treatment.

FIG. 4A, FIG. 4B, FIG. 4C and FIG. 4D are graphs showing HLB disease progress on Midsweet orange trees in the MidFlorida area. Treatment 18 (T18; non-treated control with conventional citrus fertilization, pest and weed control, without plant defense inducer) was repeated in each panel to facilitate treatment comparison. Treatments 1-17 (T1-T17) were as indicated in Example 4. The average disease severity scores were calculated from evaluations of the treated trees. Bars represent standard errors of the mean values. N=162 plants, with 9 replicates for each treatment. See Example 4.

FIG. 5 provides data regarding the relative expression of the β-1,3-glucanase gene (PR-2) in Midsweet orange leaves after a single application of different plant defense inducer compounds. Plants were treated with BTH (1.0 mM), 2-DDG (100 μM), BTH (1.0 mM) plus AA (600 μM), and BTH (1.0 mM) plus 2-DDG (100 μM) respectively. See Example 4. The relative expression change (Treatment vs Control) was calculated using the 2^{-ΔΔCt} method. Values represent the mean of three biological replicates and each sample consisted of combined four leaves from one plant (a total of three plants were assayed per treatment). Bars represent standard error. Asterisks indicate a significant difference (P<0.05) between the treatment and non-treated control based on Student's t-test. DAT=Day after treatment.

FIG. 6 provides data regarding the severity of HLB disease in plants, expressed as the standardized area under the disease progress stairs (sAUDPS) with Midsweet orange in the MidFlorida area over time. Bars represent standard errors of the mean values. Asterisks indicate a significant difference (P<0.05) between the treatment and non-treated control based on Student's t-test. See Example 4.

FIG. 7A and FIG. 7B are graphs showing HLB disease progress on Murcott mandarin trees at Lake Wales, Fla. Treatment 1 (T1; non-treated control with conventional citrus fertilization, pest and weed control program without plant defense inducer) was repeated in each panel to facilitate treatment comparison. Treatments 2 to 11 (T2 to T 11) were as indicated in Example 5. The average disease severity scores were calculated from evaluations of the treated trees. Bars represent standard errors of the mean values.

FIG. 8 provides data regarding the severity of HLB disease in plants, expressed as the standardized area under the disease progress stairs (sAUDPS) with Murcott mandarin trees at Lake Wales, Fla., over time. Bars represent standard errors of the mean values. Asterisks indicate a significant difference (P<0.05) between the treatment and non-treated control based on Student's t-test. See Example 5.

FIG. 9A and FIG. 9B are graphs showing HLB disease progress on Valencia sweet orange trees at Lake Wales, Fla. Treatment 1 (T1; non-treated control with conventional citrus fertilization, pest and weed control program without plant defense inducer) was repeated in each panel to facilitate treatment comparison. Treatments 2 to 11 (T2 to T 11) were as indicated in Example 6. The average disease severity scores were calculated from evaluations of the treated trees. Bars represent standard errors of the mean values.

FIG. 10 provides data regarding the severity of HLB disease in plants, expressed as the standardized area under the disease progress stairs (sAUDPS) with Valencia sweet orange, over time. Bars represent standard errors of the mean values. Asterisks indicate a significant difference (P<0.05) between the treatment and non-treated control based on Student's t-test. See Example 6.

### DETAILED DESCRIPTION OF THE INVENTION

### 1. Introduction

The invention is described herein with reference to specific embodiments. However, various modifications and changes can be made to the invention without departing from its broader spirit and scope. The specification and drawings therefore are to be regarded as illustrative rather than restrictive. Throughout this specification and the claims, unless the context requires otherwise, the word “comprise” and its variations, such as “comprises” and “comprising,” are used to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

In this study, the effects of various chemical plant defense inducer treatments were evaluated for activation of natural plant defense mechanisms against citrus HLB, under field conditions. The plant defense inducing agents tested improve plant defenses against disease, with the effect of increasing the health and growth of plants, including reducing disease severity by between 15 and 30% with corresponding effects on fruit yield. Therefore, this approach can be used to treat, for example, plants that have been infected with, plants that are susceptible to infection with (including uninfected plants), or plants that exhibit symptoms of HLB disease or infection with a Candidatus Liberibacter species. Examples of such species include Candidatus Liberibacter asiaticus, Candidatus Liberibacter americanus, Candidatus Liberibacter africanus, and any combination thereof.

While a number of embodiments of the present invention have been shown and described herein in the present context, such embodiments are provided by way of example only, and not of limitation. Numerous variations, changes and substitutions will occur to those of skill in the art without materially departing from the invention herein. Any means-plus-function and step-plus-function clauses are intended to cover the structures and acts, respectively, described herein as performing the recited function and not only structural equivalents or act equivalents, but also equivalent structures or equivalent acts, respectively. Accordingly, all such modifications are intended to be included within the scope of this invention as defined in the following claims, in accordance with relevant law as to their interpretation.

### 2. Definitions

All technical and scientific terms used herein, unless defined herein, are intended to have the same meaning as commonly understood by one of ordinary skill in the art. The techniques employed herein are also those that are known to one of ordinary skill in the art, unless stated otherwise.

The term “applying,” “application,” “administering,” “administration,” and all their cognates, as used herein, refers to any method for contacting the plant with the plant defense inducer compounds and compositions discussed herein. Administration generally is achieved by application of the compounds in a vehicle compatible with the plant to be treated (i.e., a botanically compatible vehicle or carrier), such as an aqueous vehicle, to the plant or to the soil surrounding the plant or by injection into the plant. Any application means can be used, however preferred application methods include trunk injection and foliar spraying as described herein. Other methods include application to the soil surrounding the plant, by injection, soaking or spraying, so that the applied compounds can come into contact with the plant roots and can be taken up by the roots.

The term “botanically acceptable carrier/vehicle” or “botanically compatible carrier/vehicle,” as used herein, refers to any non-naturally occurring vehicle, in liquid, solid or gaseous form which is compatible with use on a living plant and is convenient to contain a substance or substances for application of the substance or substances to the plant, its leaves or root system, its seeds, the soil surrounding the plant, or for injection into the trunk, or any known method of application of a compound to a living plant, preferably a crop plant, for example a citrus tree.

Useful vehicles can include any known in the art, for example liquid vehicles, including aqueous vehicles, such as water, solid vehicles such as powders, granules or dusts, or gaseous vehicles such as air or vapor. Any vehicle which can be used with known devices for soaking, drenching, injecting into the soil or the plant, spraying, dusting, or any known method for applying a compound to a plant, is contemplated for use with embodiments of the invention. Typical carriers and vehicles contain inert ingredients such as fillers, bulking agents, buffers, solvents, preservatives, anti-caking agents, pH modifiers, surfactants, soil wetting agents, adjuvants, and the like. Suitable carriers and vehicles within this definition also can contain additional active ingredients such as plant defense inducer compounds, nutritional elements, fertilizers, pesticides, and the like.

The term “Citrus” or “citrus”, as used herein, refers to any plant of the genus Citrus, family Rutaceae, and includes Citrus maxima (Pomelo), Citrus medica (Citron), Citrus micrantha (Papeda), Citrus reticulata (Mandarin orange), Citrus trifolata (trifoliate orange), Citrus japonica (kumquat), Citrus australasica (Australian Finger Lime), Citrus australis (Australian Round lime), Citrus glauca (Australian Desert Lime), Citrus garrawayae (Mount White Lime), Citrus gracilis (Kakadu Lime or Humpty Doo Lime), Citrus inodora (Russel River Lime), Citrus warburgiana (New Guinea Wild Lime), Citrus wintersii (Brown River Finger Lime), Citrus halimii (limau kadangsa, limau kedut kera); Citrus indica (Indian wild orange), Citrus macroptera, and Citrus latipes. Hybrids also are included in this definition, for example Citrus×aurantiifolia (Key lime), Citrus×aurantium (Bitter orange), Citrus×latifolia (Persian lime), Citrus×limon (Lemon), Citrus×limonia (Rangpur), Citrus×paradisi (Grapefruit), Citrus×sinensis (Sweet orange), Citrus×tangerina (Tangerine), Poncirus trifoliata×C. sinensis (Carrizo citrange), and any other known species or hybrid of genus Citrus. Citrus known by their common names include, Imperial lemon, tangelo, orangelo, tangor, kinnow, kiyomi, Minneola tangelo, oroblanco, sweet orange, ugli, Buddha's hand, citron, lemon, orange, bergamot orange, bitter orange, blood orange, calamondin, clementine, grapefruit, Meyer lemon, Rangpur, tangerine, and yuzu, and these also are included in the definition of citrus or Citrus.

The term “effective amount” or “therapeutically effective amount,” as used herein, means any amount of the compound or composition which serves its purpose, for example, treating plant disease, improving the ability of plants to defend against disease, reducing disease symptoms, treating HLB disease, minimizing crop yield decreases due to plant disease, improving crop productivity, and increasing crop quality.

The term “faster growth,” as used herein, refers to a measurable increase in the rate of growth of a plant, including seedlings, stems, roots, seeds, flowers, fruits, leaves and shoots thereof.

The term “health,” as used herein, refers to the absence of illness and a state of well-being and fitness, and refers to the level of functional or metabolic efficiency of the plant, including the ability to adapt to conditions and to combat disease, while maintaining growth and development. The term “vigor,” as used herein, refers to the health, vitality and hardiness of a plant, and its capacity for natural growth and survival. Therefore, the phrase “health and vigor of a plant,” as used herein, means the absence of illness, a high level of functional or metabolic efficiency, the ability to combat disease, and the maintenance of good growth and development, and the efficient production of crops.

The term “healthy,” as used herein, refers to a plant or plant population which is not known currently to be affected by a plant disease.

The term “Huanglongbing,” “Huanglongbing disease,” or “HLB,” as used herein, refers to a disease of plants caused by microorganisms of the Candidatus genus Liberibacter, such as L. asiaticus, L. africanus, and L. americanus. This disease, for example, can be found in citrus plants, or other plants in the genus Rutaceae. Symptoms of Huanglongbing disease include one or more of yellow shoots and mottling of the plant leaves, occasionally with thickening of the leaves, reduced fruit size, fruit greening, premature dropping of fruit from the plant, low fruit soluble acid content, fruit with a bitter or salty taste, or death of the plant. The term “treating” or “treatment,” or its cognates, as used herein indicates any process or method which cures, diminishes, ameliorates, or slows the progress of the disease or disease symptoms. Thus, treatment includes reducing bacterial titer in plant tissues or appearance of disease symptoms relative to controls which have not undergone treatment.

The term “improved ability to defend against disease,” as used herein, refers to a measurable increase in plant defense against a disease. This can be measured in terms of a measurable decrease in disease symptoms, pathogen titer, or loss of crop yield and/or quality, or a measurable increase in growth, crop quantity or quality.

The term “improved crop productivity,” as used herein, refers to a measurable increase in the quantity of a crop in a plant or a population of plants, in terms of numbers, size, or weight of crop seeds, fruits, vegetable matter, fiber, grain, and the like.

The term “improved crop quality,” as used herein, refers to a measurable increase in the quality of a crop, in terms of numbers, size, or weight of crop seeds, fruits, vegetable matter, fiber, grain, and the like, or in terms of sugar content, juice content, unblemished appearance, color, or taste.

The term “improved resistance to disease,” as used herein, refers to an increase of plant defense in a healthy plant or a decrease in disease severity of a plant or a population of plants, or in the number of diseased plants in a plant population.

The term “measurable increase” (or “measurable decrease”), as used herein, means an increase (or decrease) that can be detected by assays known in the art as greater (or less) than control. For example, a measurable increase (or decrease) is an increase (or decrease) of about 2%, about 5%, about 10%, about 20%, about 30%, about 40%, about 50%, about 60%, about 70%, about 75%, about 80%, about 85%, about 90%, or more, compared to plants or a plant population not treated with the active ingredient.

The term “minimizing crop yield decreases due to plant disease,” as used herein, refers to reducing the decrease in crop yield which is seen when a plant is infected with a disease or plant pathogen.

The term “plant in need thereof,” as used herein, means any plant which is healthy or which has been diagnosed with a plant disease or symptoms thereof, or which is susceptible to a plant disease, or may be exposed to a plant disease or carrier thereof.

The term “plant disease,” as used herein, refers to any disease of a crop plant, caused by any plant pathogen, including but not limited to bacterial, viral, fungal, nematode, phytomyxean, protozoan, algal and parasite plant pathogens.

The term “plant disease symptoms,” as used herein, refers to any symptom of disease, including the detectable presence of a known plant pathogen, or the presence of rot, mottling, galls, discoloration such as yellowing or browning, fruit greening, stunted growth, plant death, cellular death, cell wall breakdown, the presence of spots, the presence of lesions, dieback, wilting, dwarfing, knots, and Witch's broom.

The term “population of plants,” as used herein, refers to a group of plants, all of the same species, that inhabit a particular area at the same time. Therefore, the plants in a nursery, a grove, a farm, and the like are considered a population.

The term “reduction of disease symptoms,” as used herein, refers to a measurable decrease in the number or severity of disease symptoms.

The term “treating,” treatment,” and all its cognates, as used herein, refers to any application or administration to a plant, the soil surrounding the plant, the water applied to the plant, or the hydroponic system in which the plant is grown, which is intended to improve the health, growth or productivity of a plant, particularly a crop plant. For example, a treatment intended to increase the health or growth or a crop plant, increase crop yield of a plant or population of plants is contemplated as part of this definition, as well as treatment intended to improve disease symptoms or pathogen titer in the plant.

### 3. Overview

The invention relates to defense inducing compounds that are able to induce plant resistance effective against pathogens involved in disease in plants, as well as increase certain aspects of the health and vigor of any plant, including healthy plants. For example, these compounds can be useful for treating plant disease, improving the ability of plants to defend against disease, reducing disease symptoms, treating HLB disease, minimizing crop yield decreases due to plant disease, improving crop productivity, and increasing crop quality. The effects of various chemical inducers were evaluated on HLB diseased citrus groves (including sweet orange and mandarin) in Florida, in the United States for 2 to 4 consecutive growing seasons. Results demonstrated that plant defense inducers BABA or a salt thereof; SA or a salt thereof; OA or a salt thereof; and 2-DDG or a salt thereof were able to have one or more of these effects.

For example, the following treatments were applied three or four times during each season: AA (60-600 μM), BABA (0.2-1.0 mM), 2-DDG (100 μM), and were able to slow down the population growth in planta of Candidatus Liberibacter asiaticus, the putative pathogen of HLB, and reduce HLB disease severity by approximately 15 to 30% compared to the non-treated control, depending on the age and initial HLB severity of the infected trees. See the examples for the effects of treatments according to the invention. Treatments according to the invention also conferred a positive effect on fruit yield and quality. Altogether, these findings indicate that plant defense inducers are a useful strategy for the management of citrus pathogens and citrus HLB. In the present work, we report, inter alia, the effectiveness of certain plant defense inducer compounds, individually or in combination, suppressing Las population growth and HLB disease progress in infected citrus after field applications for two to four consecutive growing seasons. Also, the compound BABA is shown to improve juice quantity and quality in citrus plants.

### 4. Description

### INTRODUCTION

Methods and compounds for use in enhancing the resistance to disease in plants are needed in the art, both to improve the productivity of healthy plants and to increase the plant's natural ability to combat disease and retain good crop productivity when infected. Embodiments of this invention provide methods and compositions to assist in these goals, and to treat plants that are affected by disease as well. For example, plants treated according to embodiments of the invention can exhibit defense against disease progression and disease symptoms, for example against HLB or Ca. Liberibacter infection. In the following description, for the purposes of explanation, certain specific details are set forth in order to provide a thorough understanding of the present invention. It will be apparent, however, to one skilled in the art, that the present invention may be practiced without these specific details.

Compounds have been shown to reduce bacterial growth and HLB disease symptoms in plants, and to have increased expression (mRNA) of certain plant defense-related genes in plants. Preferred compounds for this use are β-aminobutyric acid (BABA, D,L-2-aminobutyric acid) or a salt thereof; salicylic acid (SA) or a salt thereof; 2-deoxy-D-glucose (2-DDG) or a salt thereof; oxalic acid (OA) or a salt thereof; and any combination thereof.

Some compounds have the ability to induce systemic resistance in plants providing them with an advantage against plant pathogens and improving their general condition. The resulting induced systemic resistance (ISR) allows the plant to evoke stronger and faster defense responses against a broad spectrum of pathogens in a systemic way. Physiologically, the ISR response is similar to the systemic acquired resistance (or SAR), triggered after an encounter with some plant pathogens. Both ISR and SAR are similar in the resulting defense against a broad number of pathogens. However, some differences exist between the responses. While SAR is thought to be activated through the salicylic acid pathway and accumulate PRs as a consequence, ISR is believed to be activated through the ethylene/jasmonate (ET/JA) pathways and whether PRs accumulate is less understood. Plant defense responses were monitored using qRT-PCR by studying expression of selected defense genes on the leaf tissue. Genes involved in the ethylene/jasmonate (I/J) and salicylic acid (SA) pathways, as well as pathogensis-related (PR) protein-encoding genes were used as markers.

Plants

The studies described herein have shown that the compounds and compositions according to embodiments of the invention have desirable effects on citrus plants, their productivity and their ability to combat disease. These effects are generalized and widespread, and can provide benefits to the health and vigor of citrus plants, and improvements in fighting a wide variety of diseases. Any plant is contemplated for use with the invention, both healthy plants and those which have been exposed to or may be exposed to a plant pathogen or a carrier of a plant pathogen.

Preferred plants for use with the invention include citrus. The invention is contemplated for use on plants at all stages of development, including seeds, seedlings and mature plants, which are cultivated by any method known in the art which is convenient for the plant in question. Citrus plants in the field, on farms or in a natural environment are included as useful for practicing the invention, as well as plants in a nursery or greenhouse, or a raised bed, home garden, or hydroponics facility, on a large or small scale.

Compounds

Spray treatment of HLB-diseased trees with BABA and 2-DDG was able to slow the increase of Ca. Liberibacter asiaticus population in citrus plants. Trunk injection methods using SA, OA, and BABA also reduced the Ca. Liberibacter asiaticus population in citrus. These compounds, which act as plant defense inducers, therefore contribute to HLB control by reducing the bacterial growth and disease symptoms in important crop plants. Without wishing to be bound by theory, it is possible that SA exerts its effect on reducing growth of Ca. Liberibacter asiaticus by inducing plant defense and OA reduces Las growth by reducing pH in planta.

BABA is a non-protein amino acid and showed consistent control effect against HLB, as demonstrated here. BABA can also trigger plant defenses against insects, including the Asian citrus psyllid. In high doses, BABA can suppress plant growth, therefore, doses should be optimized to induce plant defenses without suppressing growth. Persons of skill are able to adjust these doses depending on the conditions.

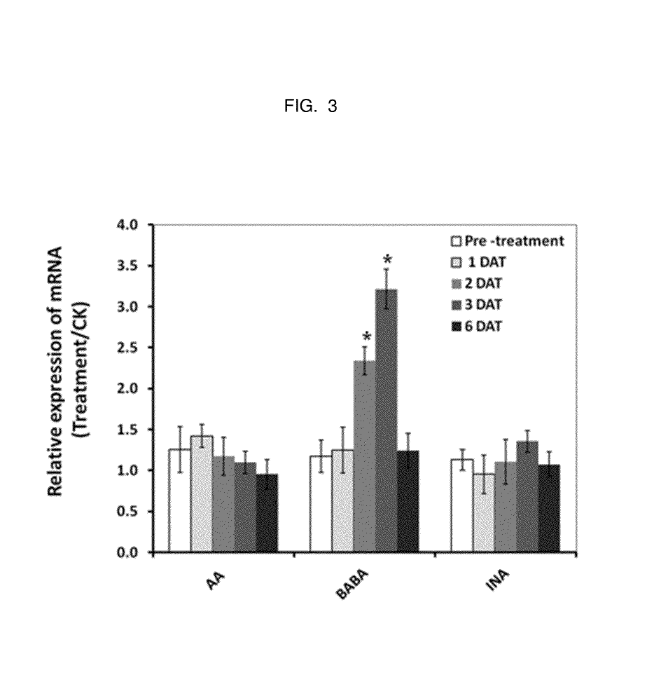

BABA can induce plant resistance by priming of SA-dependent and SA-independent defense mechanisms. Without wishing to be bound by theory, the SA-dependent induction of plant resistance by BABA is thought to involve activation of SA-inducible defense genes and to require a functional NPR1 protein, whereas SA-independent BABA is thought to induce resistance by priming of pathogen-induced callose and to require biosynthesis and perception of abscisic acid (ABA). The control effect of BABA on citrus HLB as demonstrated here seems to involve SA-dependent pathways rather than the callose since induction of PR-2 gene by BABA was observed (see, for example FIG. 3). Induction by BABA of the calS1 gene, which encodes a callose synthase 1, was not observed.

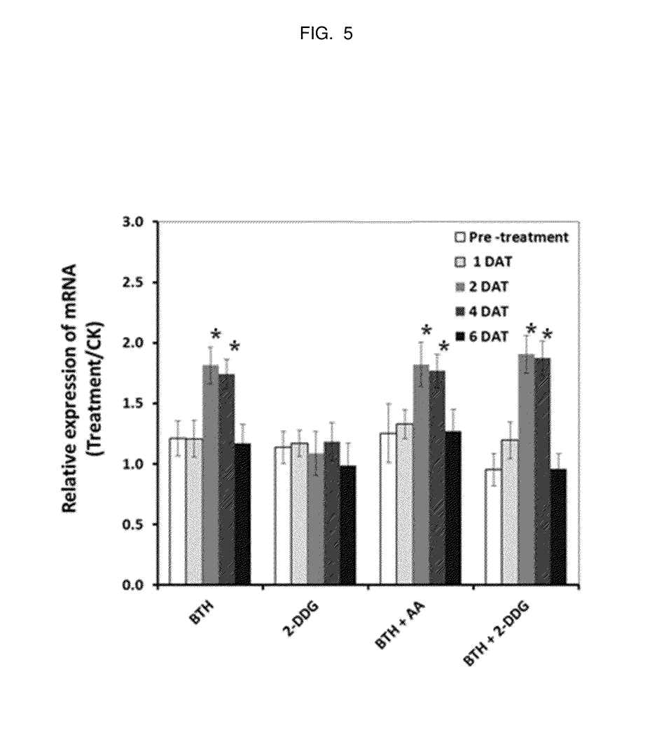

BABA-induced resistance has been reported to have long-lasting effect. In this study, application of BABA led to induction of PR2 gene at 2 and 3 days after treatment, but not at 6 days after treatment. Without wishing to be bound by theory, this could be due to the presence of salicylic acid (SA) hydroxylase, encoded by Las, which degrades SA. The degradation effect of SA hydroxylase on SA might explain the drop of PR2 gene expression in other treatments, e.g. BTH (see FIG. 5). However, this study did not rule out other possibilities for the time span of BABA-induced resistance (for example, differences in application methods).

Salicylic acid (SA) is a phenolic phytohormone, found in certain plants, which has effects related to plant growth and development, photosynthesis, transpiration, ion uptake and transport. SA also is involved in endogenous signaling and has some role in mediating in plant defense against pathogens. https://en.wikipedia.org/wiki/Salicylic_acid-cite_note-16 It is believed to induce the production of proteins as part of systemic acquired resistance (SAR).

2-DDG is a non-metabolizable glucose analogue which showed a positive control effect against HLB (see Example 7, Table 10). 2-DDG is known as an inhibitor of glucose metabolism that inhibits the glycolytic pathway, and has been found to inhibit the intracellular multiplication of the human bacterial pathogen Legionella pneumophila in AUJ mouse macrophages (Ogawa et al., 1994) and induce the lysis of growing cultures of Streptococcus bovis (Russell and Wells, 1997). Las encodes a glucose transporter and is capable of importing 2-DDG, however, Las is incapable of metabolizing 2-DDG (Duan et al., 2009). Hence, theoretically, 2-DDG might have the potential to hamper Las cell growth. 2-DDG also inhibits the growth of several postharvest fungal pathogens, including, Botrytis cinerea, Penicillium expansum, and Rhizopus stolonifer (resulting in cellular injuries such as cell wall disruption and cytoplasm disintegration) and provides partial control over the decay of apple and peach fruit. In yeast, 2-DDG can cause erosion of preformed cell wall and prevent the biosynthesis of β-1, 3-glucan, which has been identified in the EPS of Agrobacterium spp. and a few Rhizobium strains which are closely related to Las. Therefore, theoretically, it is possible that 2-DDG could interfere with the β-1, 3-glucan biosynthesis of Las, Agrobacterium and Rhizobium. In addition, 2-DDG can inhibit callose deposition, which can contribute to HLB symptom development, and thereby theoretically can at least partially explain its alleviation of HLB symptoms here.

Effects

Without wishing to be bound by theory, the compounds discussed herein beneficially affect plants to which they are exposed, by increasing the expression of certain genes in the plant, at least some of which are related to the natural plant defense mechanisms of the plant. The compounds improve the metabolism of the plant, thereby enhancing growth, productivity and disease resistance and the ability to combat disease. The data provided herein show both plant disease defense effects on plant pathogens, and also general effects on productivity such as reduction in crop loss, and improvements in juice quantity and quality.

Plant Diseases

Diseases affecting plants which are contemplated for use with the invention include diseases of citrus, not limited to:

Bacterial diseases (bacterial spot, black pit (fruit), blast, citrus canker, citrus variegated chlorosis, huanglongbing (citrus greening);

Viral diseases (citrus mosaic, bud union crease, citrus leaf rugose, citrus yellow mosaic, crinkly leaf, infectious variegation, navel infectious mottling, psoriasis, satsuma dwarf, tatter leaf, tristeza, citrus leprosis); and

Fungal diseases (albinism, alternaria brown spot, anthracnose, areolate leaf spot, black mold rot, black root rot, black rot, blue mold, botrytis, branch knot, brown rot (fruit), charcoal root rot, citrus black spot, dumping off, dry rood complex, dry rot, fly speck, fusarium, green mold, heart rot, leaf spot, mucor fruit rot, phomopsis stem-end rot, phymatotrichum root rot, phytophthora, pink disease, pink mold, pleospora rot, poria root rot, post bloom fruit drop, powdery mildew, rootlet rot, rosellinia root rot, scab, sclerotinia twig blight, septoria spot, sooty blotch, sour rot, sweet orange scab, thread blight, Trichoderma rot, twig blight, ustulina root rot, whisker mold and white root rot).

Additional diseases of major crop plants include, but are not limited to bacterial, fungal and viral diseases as are known in the art.

A person of skill in the art is aware of methods for determining whether a plant is in need of treatment for a plant disease (for example HLB or Ca. Liberibacter infection), and which plants may be or may become susceptible to a plant disease. Therefore, the invention described and claimed herein is contemplated for use in any plant which is or which may become infected with a plant disease, as determined by a person of skill Methods according to embodiments of the invention preferably are used when the person of skill in the art becomes aware of a plant with early symptoms of HLB disease on leaves, which may be small and upright, with vein yellowing and an asymmetrical chlorosis referred to as “blotchy mottle.” Methods according to embodiments of the invention also advantageously can be used when a person of skill in the art becomes aware that a plant is becoming infected by HLB as determined using PCR methods known in the art, for example quantitative real time PCR (qPCR) tests. Of course, the inventive methods also can be used prophylactically or in a more severely infected plant with disease of longer standing.

Methods of Administration

Persons of skill are aware of various methods to apply compounds, including the compounds of the invention, to plants for surface application or for uptake, and any of these methods are contemplated for use in this invention. Methods of administration to plants include, by way of non-limiting example, application to any part of the plant, by inclusion in irrigation water, by injection into the plant or into the soil surrounding the plant, by exposure of the root system to aqueous solutions containing the compounds, by use in hydroponic or aeroponic systems, by culture of individual or groups of plant cells in media containing the inducer, by seed treatment, by exposure of cuttings of citrus plants used for grafting to aqueous solutions containing the compounds, by application to the roots, stems or leaves, or by application to the plant interior, or any part of the plant to be treated. Any means known to those of skill in the art is contemplated. Preferred modes of administration include those where the compounds are applied at, on or near the roots of the plant, or trunk injection.

Application of plant defense inducer compounds can be performed in a nursery setting, a greenhouse, hydroponics facility, or in the field, or any setting where it is desirable to treat plants to prevent the likelihood of disease, or to treat disease and its effects, for example in plants which have been or can become exposed to HLB or Ca. Liberibacter infection. The methods and compounds of this invention can be used to treat infection with any Ca. Liberibacter species or type and can be used to improve plant defenses in plants which are not infected. Thus, any plant in need, in the context of this invention, includes any and all plants for which improvements in health and vigor, growth and productivity or ability to combat disease is desired. Citrus or other plants susceptible to diseases such as HLB or infection by Ca. Liberibacter species, whether currently infected or in potential danger of infection, in the judgement of the person of skill in this and related arts, are advantageously used in the invention.

Application to seeds preferably is accomplished as follows, however any method known in the art can be used. Seeds may be treated or dressed prior to planting, by soaking the seeds in a solution containing the compounds at a dosage of active ingredient over a period of minutes or hours, or by coating the seeds with a carrier containing the compounds at a dosage of active ingredient. The concentrations, volumes, and duration may change depending on the plant.

Application to soil preferably is performed by soil injection or soil drenching, however any method known in the art can be used. These methods of administration are accomplished as follows. Soil drenching may be performed by pouring a solution or vehicle containing the compounds at a dosage of active ingredient at 0.5 to 1 gallons/tree to the soil surface in a crescent within 10 to 100 cm of the trunk on the top side of the bed to minimize runoff, and/or by using the irrigation system. Soil injection may be performed by directly injecting a solution or vehicle containing the compounds at a dosage of active ingredient into the soil within 10 to 100 cm of the trunk using a soil injector. The concentrations, volumes, and duration may change depending on the plant. These soil application methods are preferred with the compounds BABA and 2-DDG.

Application to hydroponic or culture media preferably is performed as follows, however any method known in the art can be used. A solution or vehicle containing the compounds at a dosage of active ingredient may be added into the hydroponic or culture media at final concentrations suitable for plant growth and development. The concentrations, and volumes may change depending on the plant.

Application to the roots preferably is performed by immersing the root structure in a solution or vehicle in a laboratory, nursery or hydroponics environment, or by soil injection or soil drenching to the soil surrounding the roots, as described above. Emersion of the root structure preferably is performed as follows, however any method known in the art can be used. A solution or vehicle containing the compounds at a dosage of active ingredient may be applied to the roots by using a root feeder at 0.5 to 1 gallons per tree. The concentrations, volumes, and duration may change depending on the plant.

Application to the stems or leaves of the plant preferably is performed by spraying or other direct application to the desired area of the plant, however any method known in the art can be used. A solution or vehicle containing the compounds at a dosage of active ingredient may be applied with a sprayer to the stems or leaves until runoff to ensure complete coverage, and repeat three or four times in a growing season. The concentrations, volumes and repeat treatments may change depending on the plant. These leaf application methods, such as foliar spraying are preferred with the compounds BABA and 2-DDG.

Application to the plant interior preferably is performed by injection directly into the plant, for example by trunk injection or injection into an affected limb, however any method known in the art can be used. The trunk injection method is preferred with the compounds SA, OA, and BABA.

In general, preferred methods of administration include direct injection into the plant, such as trunk injection into a tree, and soil application methods, including soil injection, soil soaking or soil spraying and preferably other methods which administer the compounds at, on, or near the roots of the plant. Additional methods of administration are spraying (e.g., foliar spraying) onto the tree or other plant to be treated, however spraying methods are not preferred. Spraying methods have been directed to control of the psyllid insects (i.e., killing the insects or repelling the insects) that spread HLB, or to control post-harvest diseases of grapefruit, however the methods according to embodiments of the invention are not designed or intended to control insects or to control post-harvest disease of the harvested fruit. In an alternative embodiment, administration of compositions disclosed herein involves foliar spray of citrus, except grapefruit.

A highly preferred method according to the invention is treatment by foliar spraying or soil drench of HLB diseased plants, such as citrus trees, with BABA and/or 2-DDG, or treatment by trunk injection of HLB diseased plants, such as citrus trees, with BABA, SA and/or OA. Plants preferably are in need of treatment for HLB or HLB symptoms, or Ca. Liberibacter infection.

Compositions

Preferably, the compounds are administered in the form of a composition containing a botanically compatible vehicle. Suitable amounts for administration to a plant are in the range of about 20 mL to about 1000 mL for trunk injection, the range of about 0.1 gallons per tree to about 0.8 gallons per tree for foliar spraying, and the range of about 0.25 gallons per to about 2 gallons per tree for soil drench and soil injection methods. Therefore, for trunk injection, amounts to be administered to a plant are about 20 mL to about 1000 mL, preferably about 100 mL to about 800 mL, and most preferably about 300 mL to about 600 mL. For foliar spraying, amounts to be administered to a plant are about 0.1 gallons per tree to about 0.8 gallons per tree, preferably about 0.2 gallons per tree to about 0.6 gallons per tree, and most preferably about 0.25 gallons per tree to about 0.5 gallons per tree. For soil drench and soil injection, amounts to be administered to a plant are about 0.25 gallons per tree to about 2 gallons per tree, preferably about 0.3 gallons per tree to about 1.5 gallons per tree, and most preferably about 0.5 gallons per tree to about 1 gallon per tree. Persons of skill in the art are able to adjust these amounts taking into account the plant size, timing of application and environmental conditions.

Concentrations of the compounds in the compositions can be in the range of about 0.05 mM to about 2 mM, preferably about 0.1 mM to about 1.5 mM, and most preferably about 0.2 mM to about 1 mM. Persons of skill in the art are able to adjust these concentrations taking into account the plant size, timing of application and environmental conditions.

Compositions according to embodiments of the invention preferably include a botanically acceptable vehicle or carrier, preferably a liquid, aqueous vehicle or carrier such as water, and at least one compound according to the invention. The composition may be formulated as an emulsifiable concentrate(s), suspension concentrate(s), directly sprayable or dilutable solution(s), coatable paste(s), dilute emulsion(s), wettable powder(s), soluble powder(s), dispersible powder(s), dust(s), granule(s) or capsule(s).

The composition may optionally include a botanically acceptable carrier that contains or is blended with additional active ingredients and/or additional inert ingredients. Active ingredients which can be included in the carrier formulation can be selected from any combination of pesticides, herbicides, plant nutritional compositions such as fertilizers, and the like. Additional active ingredients can be administered simultaneously with the plant defense inducer compounds described here, in the same composition, or in separate compositions, or can be administered sequentially.

Inert ingredients which can be included in the carrier formulation can be selected from any compounds to aid in the physical or chemical properties of the composition. Such inert ingredients can be selected from buffers, salts, ions bulking agents, colorants, pigments, dyes, fillers, wetting agents, dispersants, emulsifiers, penetrants, preservatives, antifreezes, evaporation inhibitors, bacterial nutrient compounds, anti-caking agents, defoamers, antioxidants, and the like.

Some specific embodiments of the invention are described below in the context of the Examples herein, which exemplify methods of applying plant defense inducer compounds by spraying or by injection into the trunk. Persons of skill are aware of various methods to apply chemicals to plants for surface application or for uptake, and any of these methods are contemplated for use in this invention. By way of non-limiting example, the plant defense inducer compounds of this invention may be applied to any susceptible plant by spraying or by any other convenient physical application to any surface of the plant, by inclusion in irrigation water, by injection, by exposure of the root system to aqueous solutions containing the compounds, by use in hydroponic or aeroponic systems, by culture of individual or groups of plant cells in media containing the inducer, seed treatment by exposure of seeds for seedling emergence and establishment, or by exposure of cuttings of citrus plants used for grafting to aqueous solutions containing the compounds, or by any means known to those of skill in the art.

### 5. Examples

### Example 1

### Experimental Methods

### A. General Methods

SA, BTH, and INA have low solubility in water and therefore were first dissolved in ethanol and the dissolved solutions were further diluted to desired concentrations with water. Surfactants, emulsifiers and penetrants also optionally can be added to enhance absorption of the compounds. The remaining compounds are water soluble and were dissolved in water to the desired concentration for use.

### B. Disease Severity Analysis

To estimate disease severity, the method described by Gottwald et al., 2007 (visual assessment) was applied. Briefly, each tree was divided into eight sections, i.e., an upper and lower hemisphere, and each hemisphere was subdivided into four equal sections. Then, each section was scored individually on a 0 to 5 scale that indicates the proportion of limbs expressing HLB symptoms within each section (0=no limbs; 1=1-20% limbs; 2=20-40% limbs; 3=40-60% limbs; 4=60-80% limbs; and 5=80-100% limbs). This resulted in an overall severity rating of 0 to 40 for each tree. For each experiment the disease severity data from individual evaluations were also combined into a single value that combined disease progress from the initial application (MAI of 0) until the most recent evaluation. This value, expressed as the area under the disease progress stairs (AUDPS), and its standardized (sAUDPS) form, was calculated according to the method by Simko and Piepho (2012). The AUDPS approach improves the estimation of disease progress compared to the area under the disease progress curve (AUDPC) as it gives a weight closer to optimal to the first and last observations.

### C. Yield and Fruit Quality Parameter Measurements

For the treatments showing suppressive effect on HLB disease development at 1-year after the initial application, the yield of each tree was estimated as the number of boxes of fruit per tree. One box is equivalent to approximately 90 lbs. (40.8 kg) of fruit. Yield data were collected from the trials in MidFlorida for the two-year period of 2013-2014. A composite sample from 30 ripe fruit, randomly chosen from trees within each replicate and representing the mix of symptomatic and asymptomatic fruit present on each tree, were used for quality analysis. Fruit were juiced and the percentage juice was calculated according to Gottwald et al., 2012. Juice quality was determined following standard methods described elsewhere (Gottwald et al., 2012). Fruit acidity was expressed as percent citric acid. Total soluble solids was expressed as fruit brix (the measure of sugar content in fruit; i.e., 1 g of sugar/100 g of juice is equivalent to 1° of Brix). The fruit brix acidity ratio was calculated using the data collected.

D. Quantitative Real-Time PCR (qPCR) to Estimate Las Titer in Leaf Samples

For the treatments which showed a suppressive effect against HLB disease development or progress after the initial application, the expression pattern of three plant defense-related genes in the treated citrus was determined by quantitative real time PCR. Samples were taken at four time points (1, 2, 3 or 4, and 6 days after a single application of the treatments). To estimate the Las bacterial titer in treated trees, eight leaves with mottling symptoms were collected from each tree and a combined sample of 100 mg of mid-rib was excised for DNA extraction. DNA from leaf samples was extracted using the Wizard Genomic DNA purification kit (Promega Corp., Madison, Wis., USA) following the protocol for isolating genomic DNA from the plant tissue. The extracted DNA was quantified using a nano-drop spectrophotometer (NanoDrop Technologies, Wilmington, Del.) and adjusted to 100 ng/μL. qPCR assays were performed in a 96-well plate using an ABI 7500 fast real-time PCR system (Applied Biosystems, Foster City, Calif., USA). The primer/probe set CQULA04F-CQULAP10P-CQULAO4R targeting the β-operon region of Las was used (Wang et al., 2006) and qPCR reactions were performed according to the conditions described by Trivedi et al. (2009). Each individual sample was replicated three times and the whole reaction was repeated twice. Raw data were analyzed using ABI SDS software with the default settings of the software except that the threshold was adjusted to 0.02 following the instruction of the QuantiTect Probe PCR Kits (Qiagen, MD, USA). The standard equation Y=11.607−0.288X, where Y is the estimated log concentration of templates and X is the qPCR Ct values, as described by Trivedi et al. (2009), was used to convert individual Ct values into bacterial population as genome equivalents or cells (1 cell=1 genome equivalent) per gram of samples.

### E. Real-Time Reverse Transcription PCR Analysis of Plant Gene Expression

Leaves from treated trees were collected to monitor the induction of plant defense reactions. Three biological repetitions per treatment were used per time period and each sample consisted of four leaves combined from one plant (a total of three plants were assayed per treatment). Samples were collected at 0 (pre-treatment), 1, 2, 3 and 6 days for Experiment I (Example 3) and at 0 (pre-treatment), 1, 2, 4 and 6 days for Experiment II (Example 4) after a single application of treatments and immediately frozen in liquid nitrogen and stored at −80° C. until processed.

Total RNA was extracted by grinding two leaves per sample in liquid nitrogen and 200 mg of tissue was processed using the RNeasy® Mini kit for plant tissue (Qiagen, MD, USA), Contaminated genomic DNA was removed using a TURBO DNA-free kit (Ambion, Austin, Tex.), following the manufacturer's instructions. RNA purity and quality were assessed with a NanoDrop ND-1000 spectrophotometer (NanoDrop Technologies, Wilmington, Del.). RNA concentration was adjusted to 50 ng/μL, and 2 μL of sample was used for quantitative reverse transcription-PCR (qRT-PCR) relative quantitation of gene expression.

A one-step qRT-PCR was performed with a 7500 fast real-time PCR system (Applied Biosystems, Foster City, Calif.) using a QuantiTect SYBR green RT-PCR kit (Qiagen, Valencia, Calif.) following the manufacturer's instructions. The gene specific primers used were previously designed (Fan et al, 2012; Francis et al, 2009). See Table 1 below for primer sequences. Those primers targeted the β-1, 3 glucanase (PR-2), callose synthase 1(calS1), and phloem-specific lectin PP2-like protein (pp2) genes from Citrus sinensis as indicated. The housekeeping gene encoding glyceraldehyde-3-phosphate dehydrogenase-C (GAPDH-C) was used as the endogenous control. The relative fold change in target gene expression was calculated using the formula 2^{-ΔΔCT} (Livak and Schmittgen, 2001), where ΔΔCT=(Ct_{target}−Ct_{reference})_{Treatment}(Ct_{target}−Ct_{reference})_{Control}. qRT-PCR was repeated twice with four independent biological replicates each time.

TABLE 1
Genes and Corresponding Primers for Quantitative Reverse
Transcription Polymerase Chain Reaction (qRT-PCR)

| | | | SEQ | |
|---|---|---|---|---|
| | | | ID | |
| Gene | Protein Product | Primer Sequence (5′-3′) | NO | Reference |
| PR-2 | B-1,3-glucanase | Forward: | 1 | Francis et |
| | in Citrus sinensis | TTCCACTGCCATCGAAACTG | | al., 2009 |
| | | Reverse: | 2 | |
| | | GTAATCTTGTTTAAATGAGCCTCTTG | | |
| calS1 | callose | Forward: | 3 | Fan et al., |
| | synthase I | TTTGCTCCATGGCGGTGCAGA | | 2012 |
| | | Reverse: | 4 | |
| | | TGGCTGCGGGAGTAAAGCCG | | |
| pp2 | phloem-specific | Forward: | 5 | Fan et al., |
| | lectin PP2-like | CGGATTAGACTCGTTGCCAT | | 2012 |
| | protein | Reverse: | 6 | |
| | | CGCGATGCAAAAAGTACAGA | | |
| GADPH- | glyceraldehyde-3- | Forward: | 7 | Francis et |
| C | phosphate | GGAAGGTCAAGATCGGAATCAA | | al., 2009 |
| | dehydrogenase-C | Reverse: | 8 | |
| | | CGTCCCTCTGCAAGATGACTCT | | |

### Example 2

### Initial Field Trials Using Trunk Injection

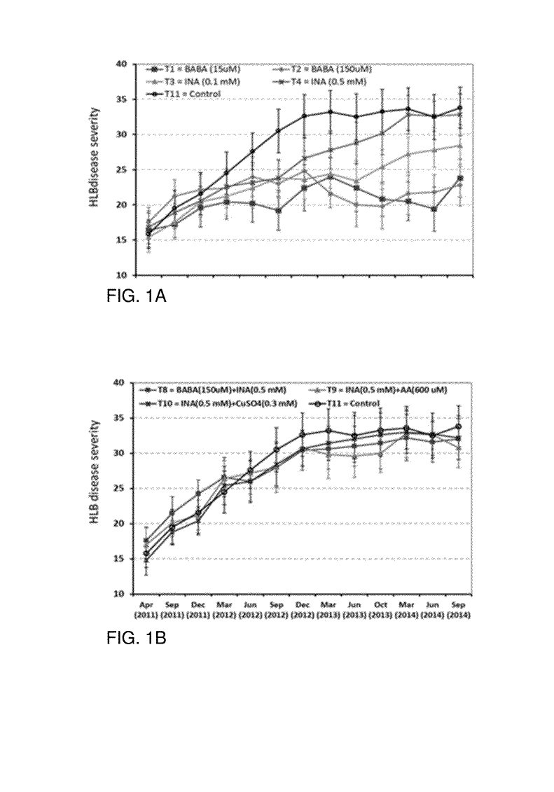

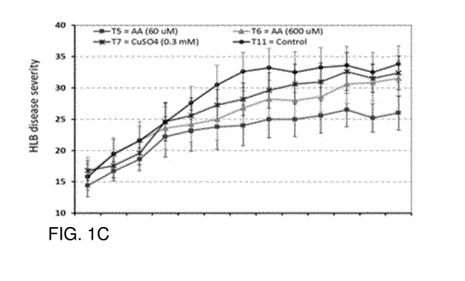

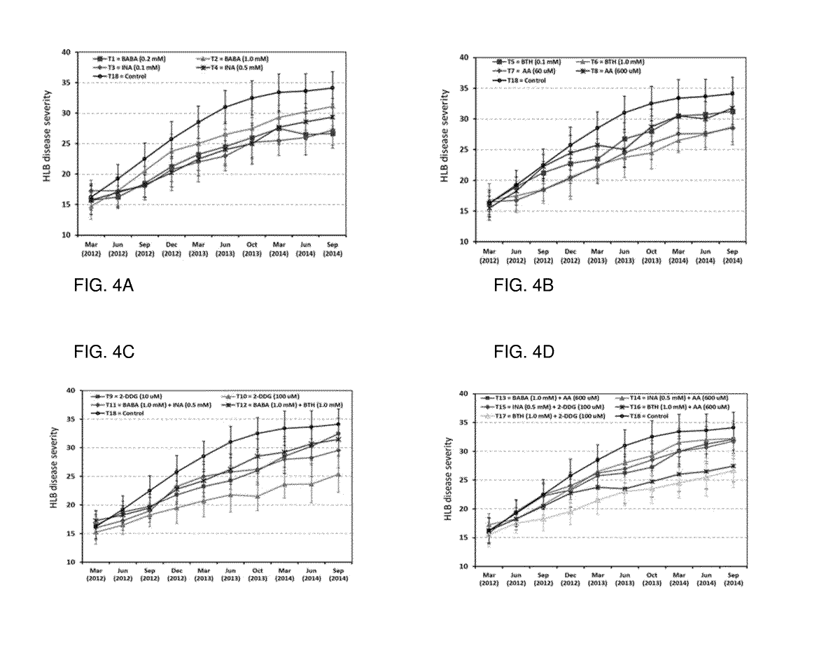

The chemical inducers salicylic acid (SA), oxalic acid (OA), potassium phosphate dibasic (PPD), acibenzolar-S-methyl (ASM; Actigard®, Syngenta, 50 WP), imidacloprid (ICD; AmTide® imidacloprid 2F, AmTide® LLC, CA), L-Ascorbic acid sodium salt (AA; 500GR), DL-2-aminobutyric acid (BABA), 2,1,3-benzothiadiazole (BTH), and 2,6-dichloro-isonicotinic acid (INA) were injected into the trunks of trees. The antibiotic oxytetracycline (OTC, Arbor-OTC™ formulation, Arborjet Inc. MA) was included as positive control. Trees used as negative controls were injected with water and are indicated as “CK” in FIGS. 4A-1A and 4B-1B.

Trunk injection of chemical inducers was carried out during a warm and sunny day. Two holes per tree were made on the main stem 30 cm directly above root flares to facilitate best uptake and canopy distribution. Holes were drilled to a depth of 2-3 cm using a 7.14 mm ( 9/32″) drill bit. A no. 3 Arborplug® was set into each hole with an Arborplug® setter and a rubber hammer to form a seal. In the first trial, a small volume of inducers was injected into a tree using a QUIK-Jet® syringe. In the second trial, a larger volume of inducers were injected using a tree I.V. MICRO INFUSION® apparatus at a low pressure of less than 50 psi. The volume and rate of injection for each treatment used in the two trials are indicated in Table 2, below. At the time of injection, the area surrounding drilling site was sprayed with Ridomil® gold (Novartis) as a preventative measure to prevent accidental infection by Phytophthora spp.

TABLE 2
Concentration and Injection Volume of Compounds for Trunk Injection Trials.

| Trial 1 (July, 2014) | | | Trial 2 (September, 2014) | | |
|---|---|---|---|---|---|
| | Rate | Volume | | Rate | Volume |
| Treatment | (mg ai/tree) | (ml/tree) | Treatment | (mg ai/tree) | (ml/tree) |
| Controls | NA | 25 | Controls | NA | 200 |
| Salicylic acid | 32 | 25 | Salicylic acid | 8 | 100 |
| Oxalic acid | 40 | 25 | Oxalic acid | 5 | 200 |
| Potassium phosphate | 40 | 25 | Potassium phosphate | 5 | 200 |
| Imidacloprid | 67 | 15 | Imidacloprid | 5 | 200 |
| Oxytetracycline | 50 | 25 | Oxytetracycline hydrochloride | 7 | 200 |
| hydrochloride | | | L-Ascorbic acid sodium salt | 5 | 200 |
| | | | DL-2-aminobutyric | 5 | 200 |

Table 3 shows the effects of the chemical inducers on the Las bacterial population, measured by quantitative real-time polymerase chain reaction qPCR of Ca. Liberibacter asiaticus in leaves of citrus trees prior to injection and one week after injection. C_{T} means cycle threshold and indicates that the number of cycles required for the fluorescent signal to cross the threshold (i.e. exceed the background level) and Ct levels are inversely proportional to the amount of target nucleic acid in the sample (i.e. the lower the Ct level, the greater amount of Las in the sample). Abbreviations for the treatments listed in Table 3 are as follows: CTRL=control, SA=salicylic acid, ASM=acibenzolar-S-methyl, OA=oxalic acid, PPD=potassium phosphate dibasic, ICD=imidacloprid, OTC=oxytetracycline hydrochloride, AA=L-Ascorbic acid sodium salt, BABA=DL-2-aminobutyric, INA=2, 6-dichloro-isonicotinic acid, BTH=2,1,3 Benzothiadiazole.

TABLE 3
Bacterial Population Effects.

| | | | | Hypothesis testing (H₀) | | | |
|---|---|---|---|---|---|---|---|
| | | | | | ΔC_{T, inducer} > | ΔC_{T, inducer ≠} | |
| Treat- | C_{T}^{u} | | | ΔC_{T} = 0 | ΔC_{T, CTRL} | ΔC_{T, OTC} | |
| ment | C_{T, 0} | C_{T, 1} | ΔC_{T}^{v} | Pr > \|t\|^{w} | Pr > t^{x} | Pr > t^{y} | Pr < t^{z} |

Trial 1 (July, 2014)

| | | | | | | | |
|---|---|---|---|---|---|---|---|
| CTRL | 24.65 | 24.01 | −0.64 | 0.1435 | | 1.0000 | 0.0079 |
| SA | 23.61 | 25.34 | 1.73 | 0.0005 | 0.0017 | 0.6054 | 0.9686 |
| OA | 23.76 | 26.59 | 2.83 | <.0001 | <.0001 | 0.0440 | 0.9999 |
| PPD | 23.92 | 26.56 | 2.64 | <.0001 | <.0001 | 0.0793 | 0.9997 |
| ICD | 24.42 | 24.50 | 0.08 | 0.8558 | 0.3634 | 0.9996 | 0.0935 |
| OTC | 27.95 | 29.28 | 1.33 | 0.0046 | 0.0079 | | |

Trial 2 (September, 2014)

| | | | | | | | |
|---|---|---|---|---|---|---|---|
| CTRL | 24.38 | 24.24 | −0.14 | 0.5708 | | 1.0000 | 0.0177 |
| SA | 23.93 | 24.88 | 0.95 | 0.0004 | 0.0125 | 0.8725 | 0.9318 |
| OA | 25.47 | 26.17 | 0.70 | 0.0032 | 0.0410 | 0.9611 | 0.8056 |
| PPD | 23.29 | 23.63 | 0.34 | 0.1662 | 0.3499 | 0.9993 | 0.2697 |
| ICD | 23.89 | 24.02 | 0.13 | 0.5791 | 0.6304 | 0.9999 | 0.0995 |
| OTC | 24.64 | 25.54 | 0.90 | 0.0008 | 0.0177 | | |
| AA | 22.15 | 21.65 | −0.50 | 0.0491 | 0.9949 | 1.0000 | 0.0012 |
| BABA | 22.10 | 22.60 | 0.50 | 0.0465 | 0.1813 | 0.9964 | 0.4693 |

^{u}C_{T, 0} = mean C_{T} values over 4 replicated trees prior to injection, C_{T, 1} = mean C_{T} values 1-week after injection.
^{v}ΔC_{T} = C_{T, 1} − C_{T, 0}.
^{w}two-tailed Dunnett's test of null hypothesis: Las titer 1-week after injection was the same as that prior to injection of inducers.
^{x}one-tailed Dunnett's test of null hypothesis: the Las titer reductions by inducers were less than that of control trees receiving water.
^{y}one-tailed Dunnett's test of null hypothesis: the Las titer reductions by inducers were less than that of control trees receiving OTC.
^{z}one-tailed Dunnett's test of null hypothesis: the Las titer reductions by inducers were higher than that of control trees receiving OTC.

While none of the chemical inducers, or the antibiotic OTC, completely eliminated the Las (Ca. Liberibacter asiaticus) titers in a tree one week after injection, the plant defense inducers SA and OA and the antibiotic OTC all significantly reduced the bacterial titer versus control in both trials. See Table 3. In addition, treatment with BABA also greatly decreased the Las population. ASM and PPD moderately reduced Las bacterial populations in the second trial, but did so with statistical significance only in the first trial. BTH, INA, and ICD did not statistically significantly reduce the Las bacterial population in either trial (Table 3). As compared to control trees receiving water, the compounds SA, OA, and OTC consistently reduced Las titers in both trials, whereas the statistically significant bacterial controlling effect of ASM and PPD was limited to the first trial (Table 3). In addition, the ΔC_{T} of SA and OA was not significantly different from that of OTC (Table 3), indicating that the Las-diminishing effects of inducers were comparable in order and magnitude to that of the antibiotic OTC.

### Example 3

### MidFlorida Foundation Grove, Trial I

This trial was conducted in a block of 7-year-old Midsweet orange (Citrus sinensis (L.) Osbeck) on Carrizo citrange (Poncirus trifoliata (L.) Raf.×C. sinensis (L.) Osbeck.) rootstock, planted in MidFlorida Foundation grove, Florida, in 2004. The experimental design was a completely randomized design with 11 treatments, each consisting of 5 trees. Treatment applications were made every three or four months when flush was present, starting with the spring flush in April 2011. Individual trees were chosen for the experiment based upon the presence of the symptoms of HLB. An attempt was made to select trees in the same stage of HLB symptom expression; i.e., initial symptoms observed in less than 30% of the canopy. All trees selected for the experiment were confirmed to be HLB-positive via a real-time quantitative polymerase chain reaction (qPCR) assay (as described in Trivedi et al., 2009). See Example 1. All trees within the trial area were maintained at commercial standards: conventional citrus insecticide, fertilizer, and herbicide applications were applied to the entire plantation.

Plant defense inducers as indicated below were applied for four consecutive growing seasons using three or four applications of about 2 liters of solution each to citrus trees by spraying. Individual treatments (T) were applied with a back pack sprayer until runoff to ensure complete coverage as follows: T1) BABA (15 μM); T2) BABA (150 μM); T3) 2, 6-Dichloroisonicotinic acid (INA) (0.1 mM); T4) INA (0.5 mM); T5) Ascorbic acid (AA) (60 μM); T6) AA (600 μM); T7) Copper Sulphate (CuSO4) (0.3 mM); T8) BABA (150 μM) and INA (0.5 mM); T9) INA (0.5 mM) and AA (600 μM); T10) INA (0.5 mM) and CuSO4 (0.3 mM); and T11) water as control. All the chemicals were purchased from Sigma (St. Louis, Mo., USA) or Fisher Scientific (Pittsburgh, Pa., USA).

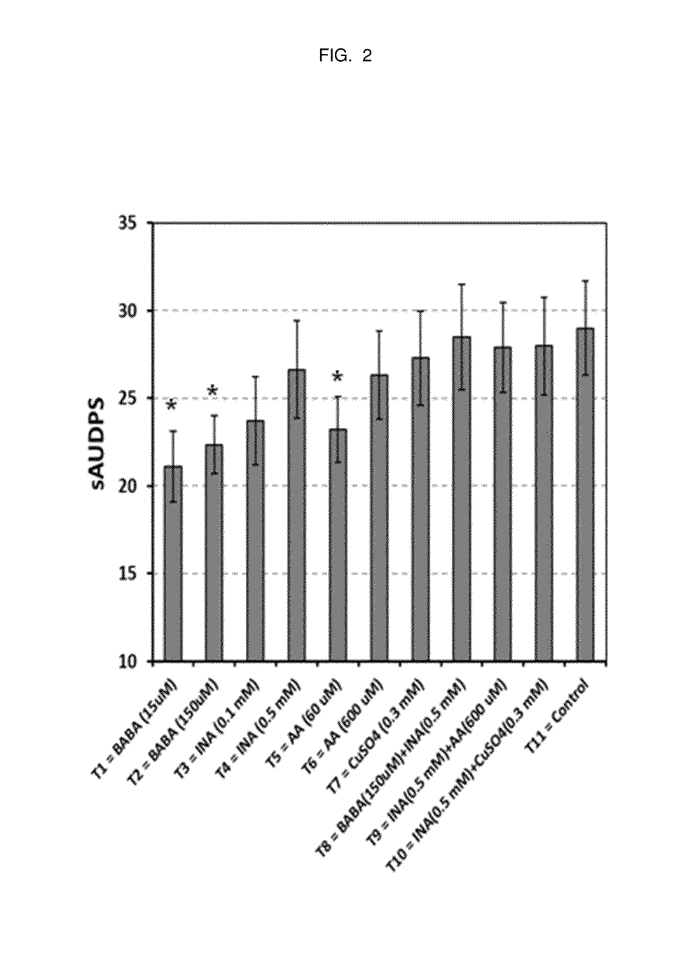

For each treatment, the HLB symptoms expressed in the plants were recorded: i.e., foliar symptoms of blotchy mottled appearance, loss of foliage, dead and dying twigs especially in the upper canopy, and foliar and fruit abscission, during 13 visual assessments from April 2011 through September 2014. These observations were consistent with the disease severity recorded over time. In this trial, the evaluations were performed at 0, 5, 8, 11, 14, 17, 20, 23, 27, 32, 35 and 38 months after initial application (MAI). The HLB symptoms generally became more severe; i.e., foliar symptoms of blotchy mottle, loss of foliage, dead and dying twigs especially in the upper canopy, and foliar and fruit abscission. These observations were consistent with the disease severity recorded over time, which showed a gradual increase in the severity score for all the treatments over time. See FIG. 1. Some inducers showed various levels of suppressive effect on HLB disease development. The HLB disease severity (expressed as sAUDPS) in the AA (60 μM), BABA (15 μM) and BABA (150 μM) treated groups was reduced by 21.3, 28.6, and 21.4% respectively, at the end of the experiment compared with the negative control. See FIG. 2.

For the treatments showing suppressive effect on HLB disease development after the initial application, we determined the expression pattern of three plant defense-related genes in citrus at four time points: 1, 2, 3, and 6 days after a single application of treatments by qRT-PCR. The Las bacterial titers in leaves of trees under these three treatments were also significantly lower than the negative control at the end of the experiment (Table 4). The mean values of Las population in the AA (60 μM), BABA (15 μM) and BABA (150 μM) treated groups were 4.91×10⁶, 4.61×10⁶, and 7.18×10⁶ cells/g of plant tissue respectively, while that of the negative control was 2.43×10⁷ cells/g of plant tissue (Table 4). The data refer to Las (Ca. Liberibacter asiaticus) bacterial titers in leaf samples from the treated plants, and are means and standard errors of three replicates. See Example 1 for methods used. In this trial, the results showed that the BABA (150 μM) induced PR-2 expression with an increase in its expression at 2 days after treatment (DAT) and peaking at 3 DAT (FIG. 3). After treatment with BABA, the levels of gene expression increased to 3.0 fold at 3 DAT compared to the negative control. However, expression of the PR-2 gene had no significant change at 6 days after BABA treatment. BABA treatment had no effect on pp2 (phloem protein-2) or calS1 expression (data not shown). The treatment AA (60 μM) or INA (0.1 mM) was not able to induce PR-2, calS1 or pp2 gene expression (FIG. 3; data not shown).

TABLE 4
Candidatus Liberibacter asiaticus (Las) titers
in Leaf Samples of Midsweet Orange.

| | Las population (Cells/g of plant tissue) | | | |
|---|---|---|---|---|
| Treatment | November 2013 | | October.2014 | |
| T1 = BABA (15 μM) | (3.67 ± 0.59) × 10⁶ | b | (4.61 ± 0.59) × 10⁶ | b |
| T2 = BABA (150 μM) | (6.48 ± 0.61) × 10⁶ | b | (7.18 ± 0.19) × 10⁶ | b |
| T3 = INA (0.1 mM) | (4.06 ± 0.25) × 10⁶ | b | (5.94 ± 0.36) × 10⁶ | b |
| T4 = INA (0.5 mM) | ND | | ND | |
| T5 = AA (60 μM) | (3.56 ± 0.57) × 10⁶ | b | (4.91 ± 0.37) × 10⁶ | b |
| T6 = AA (600 μMM) | ND | | ND | |
| T7 = CuSO4 (0.3 mM) | ND | | ND | |
| T8 = BABA (150 uM) + INA | ND | | ND | |
| (0.5 mM) | | | | |
| T9 = INA (0.5 mM) + AA | ND | | ND | |
| (600 μM) | | | | |
| T10 = INA (0.5 mM) + CuSO4 | ND | | ND | |
| (0.3 mM) | | | | |
| T11 = Negative control (water) | (1.61 ± 0.23) × 10⁷ | a | (2.43 ± 0.33) × 10⁷ | a |

Data shown are means and standard errors of three replicates.
Values with different letters within each column in the same experiment mean significant difference (P < 0.05; Student's t-test).
ND: not determined.

After treatment, the mean values of Las bacterial populations in the T5, T1 and T2 treated groups were 4.91×10⁶ cells/g, 4.61×10⁶ cells/g, and 7.18×10⁶ cells/g of plant tissue, respectively, while that of the non-treated control was 2.43×10⁷ cells/g of plant tissue, a significant decrease after treatment. The Las bacterial titers in leaves of trees under these three treatments also were reduced and suppressed compared to the non-treated control.

FIG. 1 shows HLB disease progress for the indicated treatments (T1 through T10). See FIG. 1A, FIG. 1B and FIG. 1C (bars represent standard errors of the mean values). Average disease severity scores were calculated from evaluations of the treated trees. The disease severity (expressed as sAUDPS) in the T5, T1 and T2 groups was reduced by 21.3, 28.6, and 21.4%, respectively, at the end of the experiment compared with the non-treated control. See FIG. 2 (treatment P<0.05). Bars in this figure represent standard errors of the mean values. Asterisks indicate a significant difference (P<0.05) between the treatment and non-treated control based on Student's t-test. The Las bacterial titers in leaves of trees under these three treatments were also reduced and suppressed (see Table 4), compared to the non-treated control.

Fruit yield and quality data also were collected. The fruit yield generally dropped for each treatment over the experiment duration, however, some treatments showed various levels of positive influence on fruit yield and/or quality. See Table 5. After three seasons of three or four applications each, the treatments AA, BABA and INA exhibited a higher fruit yield in 2013, compared with the negative control. See Table 5. The average weight of fruit per tree of the treatments AA (60 μM), BABA (15-150 μM) and INA (0.1 mM) was 45.2, 49.8, 52.8 and 43.8 kg fruit/tree respectively, while that of the negative control was 27.8 kg fruit/tree. The 2014 yield dropped to approximately 90% of the 2013 yield for all treatments, and the treatments AA (60 μM), BABA (15-150 μM) and INA (0.1 mM) showed a higher fruit yield than the negative control. In both years, the treatments AA (60 μM), BABA (15-150 μM) and INA (0.1 mM) exhibited a higher fruit yield than the negative control. There were no significant differences among treatments for fruit quality parameters: percent juice content or juice quality (brix, acid, or brix:acid ratio) in 2013, but in 2014, the treatment BABA (150 μM) showed a higher percent juice content and a higher brix:acid ratio than the negative control (Table 5). Each value is the mean of 5 replicate trees in each treatment. Values with different letters within each column in the same experiment indicate a significant difference (P<0.05; Student's t-test). ND: not determined.

TABLE 5
Yield and Quality of Midsweet Orange Fruit.

| | | | Quality | | | | | | | |
|---|---|---|---|---|---|---|---|---|---|---|
| | Yield | | Percent juice | | | | | | Fruit brix acidity | |
| | (kg/tree) | | content | | Fruit brix | | Fruit acidity | | ratio | |
| Treatment | 2013 | 2014 | 2013 | 2014 | 2013 | 2014 | 2013 | 2014 | 2013 | 2014 |
| T1 = BABA | 49.8 a | 47.6 a | 47.4 a | 50.1 b | 9.75 a | 10.47 a | 0.74 a | 0.71 a | 13.28 | 14.76 b |
| (15 μM) | | | | | | | | | | |
| T2 = BABA | 52.8 a | 50.3 a | 53.9 a | 58.6 a | 10.24 a | 10.34 a | 0.72 a | 0.66 a | 14.22 a | 15.66 a |
| (150 μM) | | | | | | | | | | |
| T3 = INA | 43.8 b | 40.1 b | 48.9 a | 52.6 b | 8.95 a | 9.99 a | 0.68 a | 0.67 a | 13.36 a | 14.85 ab |
| (0.1 mM) | | | | | | | | | | |
| T4 = INA | 28.4 c | 25.4 c | ND | ND | ND | ND | ND | ND | ND | ND |
| (0.5 mM) | | | | | | | | | | |
| T5 = AA | 45.2 b | 41.9 b | 50.8 a | 49.5 b | 9.92 a | 10.68 a | 0.66 a | 0.68 a | 14.17 a | 14.65 b |
| (60 μM) | | | | | | | | | | |
| T6 = AA | 27.6 c | 26.8 c | 54.6 a | 47.6 b | 9.47 a | 9.89 a | 0.69 a | 0.73 a | 13.72 a | 13.56 b |
| (600 μM) | | | | | | | | | | |
| T7 = CuSO4 | 28.4 c | 24.1 c | ND | ND | ND | ND | ND | ND | ND | ND |
| (0.3 mM) | | | | | | | | | | |
| T8 = BABA | 31.6 c | 26.1 c | 47.3 a | 50.1 b | 8.99 a | 10.16 a | 0.67 a | 0.72 a | 13.41 a | 14.05 b |
| (150 μM) + | | | | | | | | | | |
| INA (0.5 mM) | | | | | | | | | | |
| T9 = INA | 28.8 c | 24.8 c | ND | ND | ND | ND | ND | ND | ND | ND |
| (0.5 mM) + | | | | | | | | | | |
| AA (600 μM) | | | | | | | | | | |
| T10 = INA | 26.0 c | 22.9 c | ND | ND | ND | ND | ND | ND | ND | ND |
| (0.5 mM) + | | | | | | | | | | |
| CuSO4 (0.3 mM) | | | | | | | | | | |
| T11 = Neg. | 27.8 c | 24.5 c | 47.7 a | 49.6 b | 10.13 a | 10.30 a | 0.75 a | 0.71 a | 13.63 a | 14.25 b |
| control (water) | | | | | | | | | | |

### Example 4

### MidFlorida Foundation Grove, Trial II

This trial was conducted in a block of 7-year-old Midsweet orange (Citrus sinensis (L.) Osbeck) on Carrizo citrange (Poncirus trifoliata (L.) Raf.×C. sinensis (L.) Osbeck.) rootstock, planted in MidFlorida Foundation grove, Florida, in 2004. The experimental design was a completely randomized design with 18 treatments, each consisting of 9 trees. Treatment applications were made every three or four months when flush was present, starting with the spring flush in March 2012. Individual trees were chosen for the experiment based upon the presence of the symptoms of HLB. An attempt was made to select trees in the same stage of HLB symptom expression; i.e., initial symptoms observed in less than 30% of the canopy. All trees selected for the experiment were confirmed to be HLB-positive via a real-time quantitative polymerase chain reaction (qPCR) assay (as described in Trivedi et al., 2009). All trees within the trial area were maintained at commercial standards: conventional citrus insecticide, fertilizer, and herbicide applications were applied to the entire plantation.

Plant defense inducers as indicated below were applied for three consecutive growing seasons using three or four applications of about 2 liters of solution each to citrus trees by spraying. Individual treatments (T) were applied with a back pack sprayer until runoff to ensure complete coverage as follows: T1) BABA (0.2 mM); T2) BABA (1.0 mM); T3) INA (0.1 mM); T4) INA (0.5 mM); T5) 2,1,3-Benzothiadiazole (BTH) (0.1 mM); T6) BTH (1.0 mM); T7) AA (60 μM); T8) AA (600 μM); T9) 2-Deoxy-D-glucose (2-DDG) (10 μM); T10) 2-DDG (100 μM); T11) BABA (1.0 mM) and INA (0.5 mM); T12) BABA (1.0 mM) and BTH (1.0 mM); T13) BABA (1.0 mM) and AA (600 μM); T14) INA (0.5 mM) and AA (600 μM); T15) INA (0.5 mM) and 2-DDG (100 μM); T16) BTH (1.0 mM) and AA (600 μM); T17) BTH (1.0 mM) and 2-DDG (100 μM); and T18) water as control. All the chemicals were purchased from Sigma (St. Louis, Mo., USA) or Fisher Scientific (Pittsburgh, Pa., USA).

For each treatment, the HLB symptoms expressed in the plants were recorded: i.e., foliar symptoms of blotchy mottled appearance, loss of foliage, dead and dying twigs especially in the upper canopy, and foliar and fruit abscission during 10 visual assessments from March 2012 through September 2014. These observations were consistent with the disease severity recorded over time. In this trial, the evaluations were performed at 0, 3, 6, 9, 12, 15, 19, 24, 27 and 30 months after initial application (MAI). The HLB symptoms generally became more severe; i.e., foliar symptoms of blotchy mottle, loss of foliage, dead and dying twigs especially in the upper canopy, and foliar and fruit abscission. These observations were consistent with the disease severity recorded over time, which showed a gradual increase in the severity score for all the treatments over time. See FIG. 4. Some inducers showed various levels of suppressive effect on HLB disease development.

In this trial, the treatments AA (60 μM), BABA (0.2-1.0 mM), BTH (1.0 mM), INA (0.1 mM), 2-DDG (100 μM), BABA (1.0 mM) plus BTH (1.0 mM), BTH (1.0 mM) plus AA (600 μM), and BTH (1.0 mM) plus 2-DDG (100 μM) reduced HLB disease severity by 15 to 25% at the end of the experiment, compared with the negative control. See FIGS. 4 and 5. These treatments also relatively suppressed the growth of Las bacterial populations in citrus leaves compared to the negative control. See Table 6, below). FIG. 4 shows HLB disease progress in these trials for the indicated treatments. Treatment 18 (T18; non-treated control) involved conventional citrus fertilization, pest and weed control program without plant defense inducer, and was repeated in each panel to facilitate treatment comparison. The average disease severity scores were calculated from evaluations of the treated trees. Bars represent standard errors of the mean values.

For the treatments showing suppressive effect on HLB disease development after the initial application, the expression pattern of three plant defense-related genes in citrus was determined at four time points: 1, 2, 4, and 6 days after a single application of treatments by qRT-PCR. In this trial, PR-2 showed a slight induction after BTH (1.0 mM), BTH (1.0 mM) plus AA (600 μM), or BTH (1.0 mM) plus 2-DDG (100 μM) treatment at 2 DAT, and that level of expression was sustained for two more days before decreasing (FIG. 5). However, none of the three treatments had any effect on pp2 or calS1 expression (data not shown). The treatment 2-DDG (100 μM) was not able to induce PR-2, pp2 or calS1 (FIG. 5; data not shown).

At the end of the experiment, the mean value of Las population of the negative control was 2.68×10⁷ cells/g of plant tissue, while those of the treatments were from 3.91×10⁶ to 5.84×10⁶ cells/g of plant tissue (Table 6). The data refer to Las (Ca. Liberibacter asiaticus) bacterial titers in leaf samples from the treated plants, and are means and standard errors of three replicates.

Compared to the non-treated control at the end of the experiment, treatments T1, T3, T6, T7, T10, T16 and T17 (as indicated in Table 6), suppressed the growth of Las bacterial populations in citrus leaves (see Table 6) by statistically significant numbers. The mean value of Las bacterial population of the non-treated control was 2.68×10⁷ cells/g of plant tissue, while those of the treatments were from 3.91×10⁶ to 5.84×10⁷ cells/g of plant tissue (see Table 6).

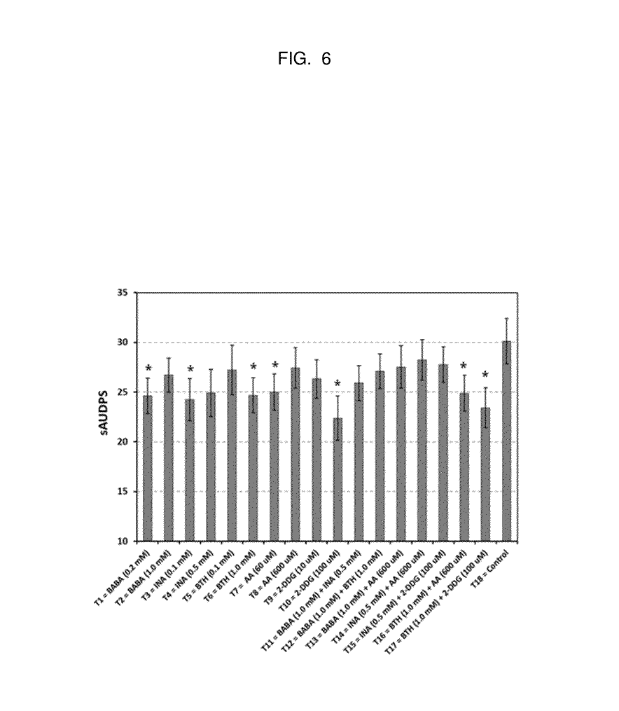

Treatments T1, T3, T6, T7, T10, T16 and T17 also reduced HLB disease severity by 15 to 25% at the end of the experiment, compared with the non-treated control (see FIG. 6; treatment P<0.05).

TABLE 6
Candidatus Liberibacter asiaticus (Las) titers in Leaf Samples of Midsweet Orange.

| | Las population (Cells/g of plant tissue) | | | |
|---|---|---|---|---|
| Treatment | November 2013 | | October.2014 | |
| T1 = BABA (0.2 mM) | (3.45 ± 0.32) × 10⁶ | b | (5.84 ± 0.25) × 10⁶ | b |
| T2 = BABA (1.0 mM) | (4.23 ± 1.22) × 10⁶ | b | (0.95 ± 0.26) × 10⁷ | a b |
| T3 = INA (0.1 mM) | (2.07 ± 0.33) × 10⁶ | b | (3.91 ± 0.85) × 10⁶ | b |
| T4 = INA (0.5 mM) | ND | | ND | |
| T5 = BTH (0.1 mM) | ND | | ND | |
| T6 = BTH (1.0 mM) | (2.72 ± 0.87) × 10⁶ | b | (5.33 ± 1.43) × 10⁶ | b |
| T7 = AA (60 μM) | (2.99 ± 0.95) × 10⁶ | b | (3.98 ± 0.81) × 10⁶ | b |
| T8 = AA (600 μM) | ND | | ND | |
| T9 = 2-DDG (10 μM) | (4.45 ± 0.94) × 10⁶ | b | (0.91 ± 0.32) × 10⁷ | a b |
| T10 = 2-DDG (100 μM) | (2.64 ± 0.76) × 10⁶ | b | (4.17 ± 1.02) × 10⁶ | b |
| T11 = BABA (1.0 mM) + INA (0.5 mM) | (6.14 ± 0.38) × 10⁶ | a b | (1.26 ± 0.41) × 10⁷ | a b |
| T12 = BABA (1.0 mM) + BTH (1.0 mM) | (6.83 ± 0.63) × 10⁶ | a b | (0.96 ± 0.33) × 10⁷ | a b |
| T13 = BABA (1.0 mM) + AA (600 μM) | (6.55 ± 0.82) × 10⁶ | a b | (0.97 ± 0.38) × 10⁷ | a b |
| T14 = INA (0.5 mM + AA (600 μM) | (7.86 ± 0.25) × 10⁶ | a b | (1.64 ± 0.16) × 10⁷ | a |
| T15 = INA (0.5 mM) + 2-DDG (100 μM) | (6.50 ± 0.64) × 10⁶ | a b | (1.41 ± 0.21) × 10⁷ | a |
| T16 = BTH (1.0 mM) + AA (600 μM) | (3.11 ± 0.65) × 10⁶ | b | (4.77 ± 0.63) × 10⁶ | b |
| T17 = BTH (1.0 mM) + 2-DDG (100 μM) | (2.49 ± 0.56) × 10⁶ | b | (4.79 ± 0.81) × 10⁶ | b |
| T18 = Negative control (water) | (1.03 ± 0.18) × 10⁷ | a | (2.68 ± 0.31) × 10⁷ | a |

Data shown are means and standard errors of three replicates.
Values with different letters within each column in the same experiment mean significant difference (P < 0.05; Student's t-test).
ND: not determined.

The fruit yield and quality data were collected. The fruit yield generally dropped for each treatment over the experiment duration, however, some treatments showed various levels of positive influence on fruit yield and/or quality. See Table 7. Each value is the mean of 5 randomly selected replicate trees in each treatment. Values with different letters within each column in the same experiment mean significant difference (P<0.05; Student's t-test). ND=not determined.

In this trial, there were no apparent differences among treatments in fruit yield (kg fruit/tree) in 2013; but in 2014, the treatments AA, BABA, BTH, 2-DDG and INA exhibited a higher fruit yield than the negative control. The 2014 yield of the treatments AA (60 μM), BABA (0.2-1.0 mM), BTH (1.0 mM), 2-DDG (100 μM), INA (0.1 mM), BABA (1.0 mM) plus BTH (1.0 mM), BTH (1.0 mM) plus AA (600 μM), and BTH (1.0 mM) plus 2-DDG (100 μM) was 36.3, 37.6, 36.5, 36.8, 35.9, 35.6, 36.6, 37.8 and 36.1 kg fruit/tree respectively, while that of the negative control was 26.9 kg fruit/tree, although the 2014 yield dropped to approximately 90% of the 2013 yield for all treatments (Table 7). Both in 2013 and 2014, the treatments AA (60 μM), BABA (0.2 mM), BTH (1.0 mM), INA (0.1 mM), 2-DDG (100 μM), BTH (1.0 mM) plus AA (600 μM), and BTH (1.0 mM) plus 2-DDG (100 μM) showed significant differences in percent fruit juice content, with a higher percent fruit juice, compared with the negative control (Table 7). The treatments AA (60 μM), BABA (0.2 mM), BTH (1.0 mM), 2-DDG (100 μM), and BTH (1.0 mM) plus 2-DDG (100 μM) also showed a higher brix:acid ratio than the negative control (Table 7).

TABLE 7
Yield and Quality of Midsweet Orange Fruit.

| | | | Quality | | | | | | | |
|---|---|---|---|---|---|---|---|---|---|---|
| | Yield | | Percent juice | | | | | | Fruit brix acidity | |
| | (kg/tree) | | content | | Fruit brix | | Fruit acidity | | ratio | |
| Treatment | 2013 | 2014 | 2013 | 2014 | 2013 | 2014 | 2013 | 2014 | 2013 | 2014 |
| T1 = BABA | 40.3 a | 37.6 a | 49.3 a | 51.2 a | 9.46 a | 10.27 a | 0.72 a | 0.69 a | 13.21 a | 14.85 a |
| (0.2 mM) | | | | | | | | | | |
| T2 = BABA | 39.2 a | 36.5 a | 40.7 b | 44.1 b | 8.88 a | 9.45 a | 0.75 a | 0.71 a | 11.86 a | 13.32 b |
| (1.0 mM) | | | | | | | | | | |
| T3 = INA | 40.5 a | 35.6 a | 50.5 a | 51.1 a | 10.06 a | 10.51 a | 0.72 a | 0.72 a | 13.87 a | 14.56 ab |
| (0.1 mM) | | | | | | | | | | |
| T4 = INA | 38.4 a | 33.9 ab | ND | ND | ND | ND | ND | ND | ND | ND |
| (0.5 mM) | | | | | | | | | | |
| T5 = BTH | 40.3 a | 33.4 ab | ND | ND | ND | ND | ND | ND | ND | ND |
| (0.1 mM) | | | | | | | | | | |
| T6 = BTH | 39.9 a | 36.8 a | 49.5 a | 51.7 a | 9.97 a | 10.68 a | 0.76 a | 0.70 a | 13.11 a | 15.22 a |
| (1.0 mM) | | | | | | | | | | |
| T7 = AA | 40.1 a | 36.3 a | 53.3 a | 51.1 a | 9.79 a | 10.56 a | 0.78 a | 0.71 a | 12.55 a | 14.87 a |
| (60 μM) | | | | | | | | | | |
| T8 = AA | 38.2 a | 33.4 ab | ND | ND | ND | ND | ND | ND | ND | ND |
| (600 μM) | | | | | | | | | | |
| T9 = 2-DDG | 40.6 a | 33.5 ab | 43.9 b | 46.1 b | 9.63 a | 10.41 a | 0.73 a | 0.67 a | 13.19 a | 15.19 a |
| (10 μM) | | | | | | | | | | |
| T10 = 2-DDG | 37.2 a | 35.9 a | 51.0 a | 52.5 a | 9.20 a | 10.10 a | 0.69 a | 0.66 a | 13.33 a | 15.17 a |
| (100 μM) | | | | | | | | | | |
| T11 = BABA | 35.6 a | 33.3 ab | 40.9 b | 42.6 b | 9.08 a | 9.48 a | 0.65 a | 0.68 a | 12.43 a | 13.92 b |
| (1.0 mM) + | | | | | | | | | | |
| INA (0.5 mM) | | | | | | | | | | |
| T12 = BABA | 38.5 a | 36.6 a | 38.9 b | 41.1 b | 8.89 a | 9.36 a | 0.65 a | 0.66 a | 13.22 a | 14.11 b |
| (1.0 mM) + | | | | | | | | | | |
| BTH (1.0 mM) | | | | | | | | | | |
| T13 = BABA | 37.3 a | 27.5 b | 38.6 b | 42.9 b | 10.01 a | 10.12 a | 0.70 a | 0.71 a | 14.27 a | 14.25 b |
| (1.0 mM) + | | | | | | | | | | |
| AA (600 μM) | | | | | | | | | | |
| T14 = INA | 35.5 a | 25.5 b | 41.6 b | 44.3 b | 8.88 a | 9.47 a | 0.68 a | 0.66 a | 13.05 a | 14.26 b |
| (0.5 mM) + | | | | | | | | | | |
| AA (600 μM) | | | | | | | | | | |
| T15 = INA | 36.7 a | 26.2 b | 40.3 b | 43.2 b | 9.52 a | 9.68 a | 0.77 a | 0.72 a | 11.75 a | 13.49 b |
| (0.5 mM) + | | | | | | | | | | |
| 2-DDG (100 μM) | | | | | | | | | | |
| T16 = BTH | 40.3 a | 37.8 a | 49.6 a | 51.4 a | 9.61 a | 9.65 a | 0.69 a | 0.71 a | 13.93 a | 14.31 b |
| (1.0 mM) + | | | | | | | | | | |
| AA (600 μM) | | | | | | | | | | |
| T17 = BTH | 39.2 a | 36.1 a | 51.4 a | 52.6 a | 9.99 a | 10.57 a | 0.76 a | 0.70 a | 13.14 a | 15.18 a |
| (1.0 mM) + | | | | | | | | | | |
| 2-DDG (100 μM) | | | | | | | | | | |
| T18 = Neg. | 34.8 a | 26.9 b | 43.8 b | 45.3 b | 9.17 a | 9.38 a | 0.71 a | 0.69 a | 12.82 a | 13.39 b |
| control (water) | | | | | | | | | | |

### Example 5

### Lake Wales, Fla., Trial III

This trial was conducted in a block of 10-year-old Murcott mandarin orange [Citrus reticulate (L.) Blanco] on Cleopatra mandarin orange [Citrus reticulate (L.) Blanco] rootstock, planted in Lake Wales, Fla. in 2003. The experiment was completely randomized with 11 treatments, each consisting of 10 replicate trees. Treatment applications were made every three or four months when flush was present starting with the spring flush in March 2013. Individual trees were chosen for the experiment based upon the presence of the symptoms of HLB. An attempt was made to select trees in the same stage of HLB symptom expression; i.e., initial symptoms observed in less than 30% of the canopy. All trees selected for the experiment were confirmed to be HLB-positive by qPCR assay according to the methods of Trivedi et al., 2009. All trees within the trial area were maintained at commercial standards as described above.

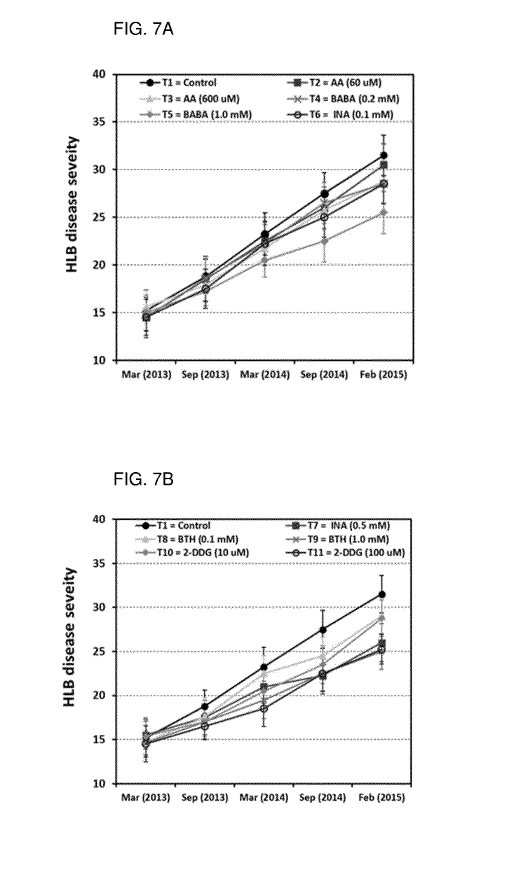

Disease severity data were recorded during 5 visual assessments from March 2013 through February 2015. Evaluations were performed at 0, 6, 12, 18 and 23 months after initial application (MAI). Plant defense inducers were applied for two consecutive growing seasons of three or four applications each by spraying. Over the experiment duration, for each treatment, the HLB symptoms generally became more severe, and included foliar symptoms of blotchy mottle, loss of foliage, dead and dying twigs especially in the upper canopy, and foliar and fruit abscission. These observations were consistent with the disease severity recorded over time, which showed a gradual increase in the severity score for all the treatments. See FIG. 7. Some inducers showed various levels of suppressive effect on HLB disease development.

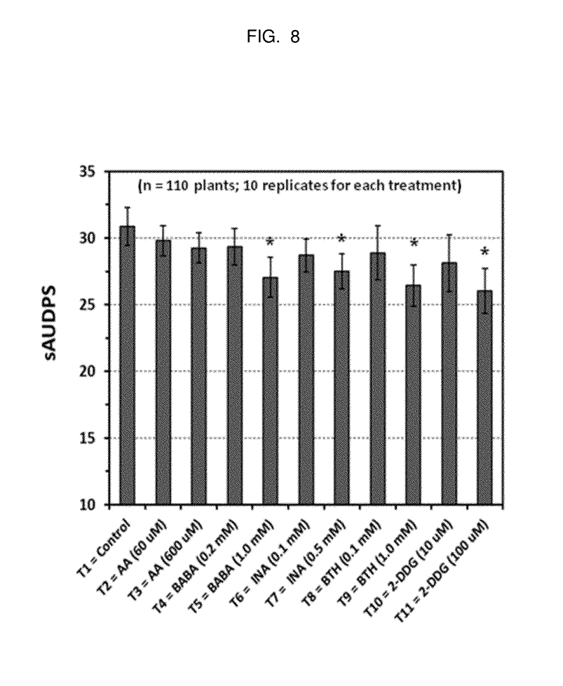

The treatments were T1) water control; T2) AA, 60 μM; T3) AA, 600 μM; T4) BABA. 0.2 mM; T5) BABA, 1.0 mM; T6) INA, 0.1 mM; T7) INA, 0.5 mM; T8) BTH, 0.1 mM T9) BTH, 1.0 mM; T10) 2-DDG, 10 μM; and T11) 2-DDG, 100 In this trial, the treatments BABA, 1.0 mM; BTH, 1.0 mM; INA, 0.5 mM and 2-DDG, 100 μM reduced HLB disease severity by 15% to 20% and suppressed the growth of Las bacterial populations in citrus leaves as compared with the negative control. See FIG. 8 and Table 8, below. At the end of the experiment, the mean value of Las-bacterium population of the treatments ranged from 1.12×10⁷ to 1.36×10⁷ cells/g of plant tissue, while that of the negative control was 5.15×10⁷ cells/g of plant tissue (Table 8). See Example 1 for methods used.

TABLE 8
Candidatus Liberibacter asiaticus (Las) titers in Murcott mandarin leaf samples.

| | | Las population (Cells/g of leaf tissue) | | | |
|---|---|---|---|---|---|
| Treatment | Mar.2013 | Sep.2013 | Mar.2014 | Sep.2014 | Feb.2015 |
| T1 = Water control | (4.25 ± 1.02) × 10⁶ a | (6.52 ± 1.05) × 10⁶ a | (1.18 ± 0.32) × 10⁷ a | (2.11 ± 0.36) × 10⁷ a | (5.15 ± 0.26) × 10⁷ a |
| T2 = AA (60 ± M) | (2.74 ± 1.12) × 10⁶ a | (3.86 ± 0.55) × 10⁶ a | (0.74 ± 0.19) × 10⁷ a | (1.52 ± 0.39) × 10⁷ a | (2.95 ± 0.48) × 10⁷ a |
| T3 = AA (600 μM) | (4.12 ± 0.78) × 10⁶ a | (5.23 ± 0.68) × 10⁶ a | (0.91 ± 0.11) × 10⁷ a | (1.84 ± 0.36) × 10⁷ a | (3.12 ± 0.22) × 10⁷ a |
| T4 = BABA (0.2 mM) | (3.56 ± 0.68) × 10⁶ a | (4.82 ± 0.75) × 10⁶ a | (0.98 ± 0.08) × 10⁷ a | (1.69 ± 0.33) × 10⁷ a | (3.52 ± 0.54) × 10⁷ a |
| T5 = BABA (1.0 mM) | (2.28 ± 1.03) × 10⁶ a | (3.65 ± 0.45) × 10⁶ a | (0.76 ± 0.11) × 10⁷ a | (0.84 ± 0.14) × 10⁷ b | (1.12 ± 0.23) × 10⁷ b |
| T6 = INA (0.1 mM) | (4.02 ± 0.86) × 10⁶ a | (5.23 ± 0.65) × 10⁶ a | (0.98 ± 0.18) × 10⁷ a | (1.57 ± 0.31) × 10⁷ a | (3.45 ± 0.36) × 10⁷ a |
| T7 = INA (0.5 mM) | (3.28 ± 0.77) × 10⁶ a | (6.52 ± 1.05) × 10⁶ a | (0.79 ± 0.19) × 10⁷ a | (0.89 ± 0.12) × 10⁷ b | (1.36 ± 0.42) × 10⁷ b |
| T8 = BTH (0.1 mM) | (2.85 ± 1.04) × 10⁶ a | (5.22 ± 0.83) × 10⁶ a | (0.92 ± 0.07) × 10⁷ a | (1.86 ± 0.28) × 10⁷ a | (3.21 ± 0.41) × 10⁷ a |
| T9 = BTH (1.0 mM) | (3.62 ± 0.87) × 10⁶ a | (4.25 ± 0.55) × 10⁶ a | (0.74 ± 0.11) × 10⁷ a | (0.82 ± 0.08) × 10⁷ b | (1.26 ± 0.25) × 10⁷ b |
| T10 = 2-DDG (10 μM) | (4.53 ± 1.17) × 10⁶ a | (7.12 ± 1.14) × 10⁶ a | (1.13 ± 0.36) × 10⁷ a | (2.06 ± 0.47) × 10⁷ a | (3.74 ± 0.54) × 10⁷ a |
| T11 = 2-DDG (100 μM) | (3.26 ± 0.72) × 10⁶ a | (4.84 ± 0.67) × 10⁶ a | (0.72 ± 0.12) × 10⁷ a | (0.79 ± 0.07) × 10⁷ b | (1.14 ± 0.23) × 10⁷ b |

Data shown are means and standard errors of three replicates.
Values with different letters within each column mean significant difference (P < 0.05; Student's t-test).
N = 110 plants, 10 replicates for each treatment as indicated above.

### Example 6

### Lake Wales, Fla., Trial IV

This trial was conducted in a block of 4-year-old Valencia sweet orange [Citrus sinensis (L.) Osbeck] Blanco] on Swingle citrumelo [Citrus paradisi Macf.×Poncirus trifoliata (L.) Raf.] rootstock planted in Lake Wales, Fla. in 2009. The experimental design was completely randomized design with 11 treatments, each consisting of 10 trees as replicates. Treatment applications were made every three or four months when flush was present starting with the spring flush in March 2013. Individual trees were chosen for the experiment based upon the presence of the symptoms of HLB. An attempt was made to select trees in the same stage of HLB symptom expression; i.e., initial symptoms observed in less than 20% of the canopy. All trees selected for the experiment were confirmed to be HLB-positive with qPCR assays (Trivedi et al., 2009). All trees within the trial area were maintained at commercial standards, as described above.

Individual treatments were applied with a back pack sprayer until runoff to ensure complete coverage as described in Example 5. All the chemicals were purchased from Sigma (St. Louis, Mo., USA) or Fisher Scientific (Pittsburgh, Pa., USA). Plant defense inducers were applied for two consecutive growing seasons of three or four applications each. Disease severity data were recorded during 5 assessments from March 2013 through February 2015. Visual evaluations of disease severity and progress were performed as described above at 0, 6, 12, 18, and 23 months after initial application.

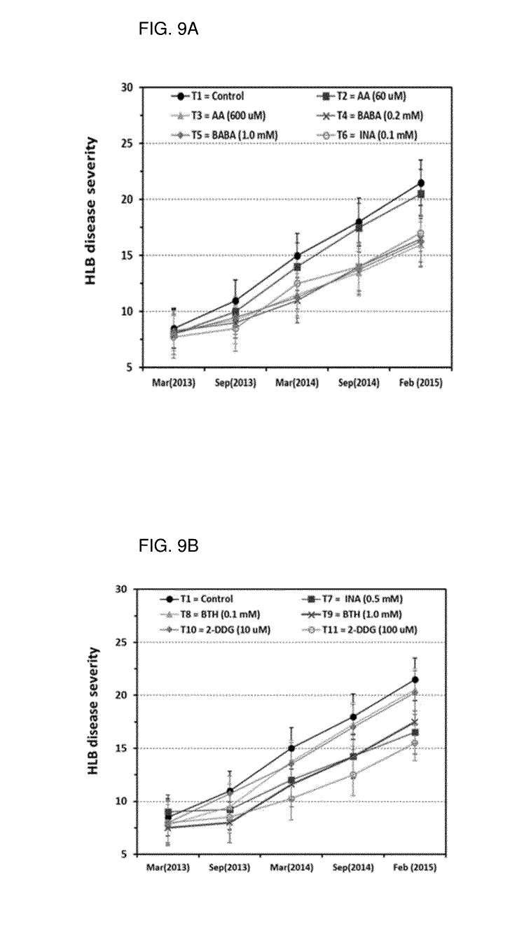

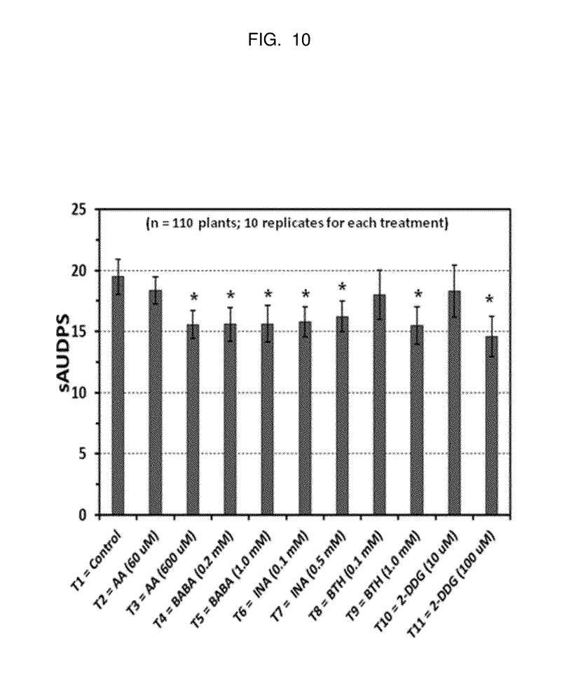

Over the course of the experiment, for each treatment, the HLB symptoms generally became more severe; i.e., foliar symptoms of blotchy mottle, loss of foliage, dead and dying twigs especially in the upper canopy, and foliar and fruit abscission. These observations were consistent with the disease severity recorded over time, which showed a gradual increase in the severity score for all the treatments. Some inducers showed various levels of suppressive effect on HLB disease development. See FIG. 9 and Table 9. In this trial, treatments T3 (AA, 600 μM), T4 and T5 (BABA, 0.2-1.0 mM), T9 (BTH, 1.0 mM), T6 and T7 (INA, 0.1-0.5 mM), and T11, 2-DDG (100 μM) were relatively more effective in suppressing HLB disease development than the trial described in Example 5. These treatments reduced the disease severity by 20 to 30% respectively at the end of the experiment, compared with the negative control. See FIG. 10. The mean value of Las-bacterium population of the negative control was 7.09×10⁶ cells/g of plant tissue, while those of the treatments were from 1.19×10⁶ to 1.83×10⁶ cells/g of plant tissue at the end of the experiment (Table 9). See Example 1 for methods used.

TABLE 9
Candidatus Liberibacter asiaticus (Las) titers in Leaf Samples of Valencia Sweet
Orange.

| | Las population (Cells/g of leaf tissue) | | | | |
|---|---|---|---|---|---|
| Treatment | Mar.2013 | Sep.2013 | Mar.2014 | Sep.2014 | Feb.2015 |
| T1 = Water control | (4.07 ± 1.04) × 10⁵ a | (0.75 ± 0.11) × 10⁶ a | (1.83 ± 0.29) × 10⁶ a | (3.41 ± 0.49) × 10⁶ a | (7.09 ± 0.27) × 10⁶ a |
| T2 = AA (60 μM) | (3.47 ± 0.42) × 10⁵ a | (0.68 ± 0.07) × 10⁶ a | (1.69 ± 0.17) × 10⁶ a | (2.89 ± 0.28) × 10⁶ a | (6.68 ± 0.29) × 10⁶ a |
| T3 = AA (600 μM) | (3.02 ± 0.58) × 10⁵ a | (0.55 ± 0.08) × 10⁶ a | (0.73 ± 0.09) × 10⁶ b | (0.93 ± 0.08) × 10⁶ b | (1. 83 ± 0.15) × 10⁶ b |
| T4 = BABA (0.2 mM) | (5.02 ± 1.06) × 10⁵ a | (0.57 ± 0.07) × 10⁶ a | (0.75 ± 0.08) × 10⁶ b | (0.97 ± 0.09) × 10⁶ b | (1.46 ± 0.19) × 10⁶ b |
| T5 = BABA (1.0 mM) | (2.95 ± 0.21) × 10⁵ a | (0.49 ± 0.15) × 10⁶ a | (0.68 ± 0.04) × 10⁶ a | (0.87 ± 0.06) × 10⁶ b | (1.63 ± 0.34) × 10⁶ b |
| T6 = INA (0.1 mM) | (4.26 ± 0.57) × 10⁵ a | (0.52 ± 0.13) × 10⁶ a | (0.73 ± 0.04) × 10⁶ b | (0.91 ± 0.12) × 10⁶ b | (1.45 ± 0.11) × 10⁶ b |
| T7 = INA (0.5 mM) | (2.96 ± 0.28) × 10⁵ a | (0.51 ± 0.12) × 10⁶ a | (0.76 ± 0.05) × 10⁶ b | (0.93 ± 0.11) × 10⁶ b | (1.48 ± 0.12) × 10⁶ b |
| T8 = BTH (0.1 mM) | (3.51 ± 1.03) × 10⁵ a | (0.68 ± 0.17) × 10⁶ a | (1.96 ± 0.15) × 10⁶ a | (2.63 ± 0.29) × 10⁶ a | (6.53 ± 0.39) × 10⁶ a |
| T9 = BTH (1.0 mM) | (3.26 ± 0.29) × 10⁵ a | (0.49 ± 0.14) × 10⁶ a | (0.72 ± 0.06) × 10⁶ b | (0.89 ± 0.12) × 10⁶ b | (1.19 ± 0.11) × 10⁶ b |
| T10 = 2-DDG (10 | | | | | |
| μM) | (4.16 ± 1.11) × 10⁵ a | (0.68 ± 0.06) × 10⁶ a | (1.76 ± 0.07) × 10⁶ b | (2.83 ± 0.16) × 10⁶ a | (6.64 ± 0.25) × 10⁶ a |
| T11 = 2-DDG (100 | | | | | |
| μM) | (4.45 ± 0.64) × 10⁵ a | (0.55 ± 0.13) × 10⁶ a | (0.86 ± 0.05) × 10⁶ b | (0.97 ± 0.14) × 10⁶ b | (1.48 ± 0.26) × 10⁶ b |

Data shown are means and standard errors of three replicates of qPCR analysis.
Values with different letters within each column mean significant difference (P < 0.05; Student's t-test).
N = 110 plants, with 10 replicates for each treatment.

### Example 7

### Exemplary and Preferred Treatments

Insecticides are currently the most widely used management tool for the psyllid vectors to reduce the transmission of Las, but psyllid populations are developing resistance to insecticides. Application of plant defense inducers can provide an additional method for managing HLB. Induction of plant defense was relatively more effective in young trees.

Treatment of trees with BABA and 2-DDG had a positive effect in suppressing Las population in the plants and sustained fruit productivity, compared to the negative control. See Table 10, below, for a summary of some of the results. Given that HLB pathogen acquisition by psyllids is positively associated with the bacterial titer in host plants (Coletta-Filho et al., 2014), reduction of Las populations in citrus also can impact pathogen acquisition spread by psyllids.

TABLE 10
Exemplary and Preferred Treatments (foliar spraying methods).

| | | | Reduction of |
|---|---|---|---|
| | | | Las titer (log |
| Example | Citrus Variety | | unit per gram |
| Number | (tree age) | Treatment^{b} | plant tissue)^{c} |
| 3 | Midsweet orange | BABA (15 μM- | 0.63 |
| | (7-year) | 150 μM) | |
| 4 | Midsweet orange | BABA (0.2 mM) | 0.66 |
| | (8-year) | | |
| 5 | Murcott mandarin | BABA (1.0 mM) | 0.66 |
| | (10-year) | 2-DDG (100 μM) | 0.66 |
| 6 | Valencia sweet orange | BABA (0.2-1.0 mM) | 0.68 |
| | (4-year) | 2-DDG (100 μM) | 0.70 |

^{a}Age at beginning of trial.
^{b}BABA: β-aminobutyric acid; 2-DDG: 2-Deoxy-D-glucose.
^{c}Reduction in populations of Candidatus Liberibacter asiaticus (Las) compared to control at the end of the experiments.

### 6. References

The following references are hereby incorporated by reference in their entirety.
1. Anand et al., 2008. Salicylic acid and systemic acquired resistance play a role in attenuating crown gall disease caused by Agrobacterium tumefaciens. Plant Physiol. 146:703-715.
2. Aubert, 1990. Integrated activities for the control of Huanglongbing-greening and its vector Diaphorina citri Kuwayama in Asia. Pages 133-144 in: Rehabilitation of Citrus Industry in the Asia Pacific Region. Proc. Asia-Pac. Int. Conf. Citri Culture. B. Aubert, S. Tontyaporn, and D. Buangsuwon, eds. Chiang Mai, Thailand.
3. Barth et al., 2006. The role of ascorbic acid in the control of flowering time and the onset of senescence. J. Exp. Bot. 57:1657-1665.
4. Beckers and Conrath, 2007. Priming for stress resistance: from the lab to the field. Curr. Opin. Plant Biol. 10:425-431.
5. Biely et al., 1971. Effect of 2-Deoxyglucose on cell wall formation in Saccharomyces cerevisiae and its relation to cell growth inhibition. J. Bacteriol. 107:121-129.
6. Bové, 2006. Huanglongbing: a destructive, newly-emerging, century old disease of citrus. J. Plant Pathol. 88:7-37.
7. Cohen, 2002. β-aminobutyric acid-induced resistance against plant pathogens. Plant Dis. 86: 448-457.
8. Cohen et al., 1994. β-Aminobutyric acid induces the accumulation of pathogenesis-related proteins in tomato (Lycopersicon esculentum L.) plants and resistance to late blight infection caused by Phytophthora infestans. Plant Physiol. 104:59-66.
9. Cohen et al., 2010. Mechanisms of induced resistance in lettuce against Bremia lactucae by DL-β-aminobutyric acid (BABA). Eur. J. Plant Pathol. 126:553-573.
10. Cohen et al., 2011. Post infection application of DL-3-amino-butyric acid (BABA) induces multiple forms of resistance against Bremia lactucae in lettuce. Eur. J. Plant Pathol. 130:13-27.
11. Coletta-Filho et al., 2014. Temporal progression of ‘Candidatus Liberibacter asiaticus’ infection in citrus and acquisition efficiency by Diaphorina citri. Phytopathology 104:416-421.
12. Duan et al., 2009. Complete genome sequence of citrus huanglongbing bacterium, ‘Candidatus Liberibacter asiaticus’ obtained through metagenomics. Mol. Plant-Microbe Interact. 22:1011-1020.
13. Durrant and Dong, 2004. Systemic acquired resistance. Annu. Rev. Phytopathol. 42: 185-209.
14. El Ghaouth et al., 1995. Sugar analogs as potential fungicides for postharvest pathogens. Plant Dis. 79:254-258.
15. El Ghaouth et al., 1997. Antifungal activity of 2-deoxy-D-glucose on Botrytis cinerea, Penicillium expansum, and Rhizopus stolonifer: Ultrastructural and cytochemical aspect. Phytopathology 87:772-779.
16. Fan et al., 2012. Comparative transcriptional and anatomical analyses of tolerant rough lemon and susceptible sweet orange in response to ‘Candidatus Liberibacter asiaticus’ infection. Mol. Plant-Microbe Interact. 25:1396-1407.
17. Footrakul et al., 1981. Extracellular polysaccharides of Rhizobium from Bangkok MIRCEN collection. J. Ferment. Technol. 59:9-14.
18. Francis et al., 2009. Soil application of imidacloprid and related SAR-inducing compounds produces effective and persistent control of citrus canker. Eur. J. Plant Pathol. 124:283-292.
19. Ghai et al., 1981. Production and chemical composition of extracellular polysaccharides of Rhizobium. J. Gen. Microbiol. 122:33-40.
20. Gottwald et al., 2007. Citrus huanglongbing: the pathogen, its epidemiology, and impact. Plant Health Prog. http://www.plant managementnetwork.org/sub/php/review/2007/huanglongbing/.
21. Gottwald, 2010. Current epidemiological understanding of citrus Huanglongbing. Annu. Rev. Phytopathol. 48:119-139.
22. Gottwald et al., 2012. Inconsequential effect of nutritional treatments on huanglongbing control, fruit quality, bacterial titer and disease progress. Crop protection 36: 73-82.
23. Graham et al., 2012. Protection of citrus roots against infection by Phytophthora spp. By hypovirulent P. nicotianae is not related to induction of systemic acquired resistance. Plant Soil 358:39-49.
24. Halbert, 2005. The discovery of huanglongbing in Florida. Page 50 in: Proc. 2nd Int. Citrus Canker and Huanglongbing Workshop, Orlando, Fla.
25. Hassan and Buchenauer, 2007. Induction of resistance to fire blight in apple by acibenzolar-S-methyl and DL-3-aminobutyric acid. Journal of Plant Diseases and Protection 114:151-158.
26. Hoffman et al., 2013. Heat treatment eliminates ‘Candidatus Liberibacter asiaticus’ from infected citrus trees under controlled conditions. Phytopathology 13:15-22.
27. Jagoueix et al., 1994. The phloem-limited bacterium of greening disease of citrus is a member of the alpha subdivision of the Proteobacteria. Int. J. Syst. Bacteriol. 44:379-386.
28. Justyna and Ewa, 2013. Induction of resistance against pathogens by β-aminobutyric acid. Acta Physiol. Plant 35:1735-1748.
29. Khan et al., 2011. A review of ascorbic acid potentialities against oxidative stress induced in plants. J. Agrobiol. 28:97-111.
30. Kim et al., 2009. Response of sweet orange (Citrus sinensis) to ‘Candidatus Liberibacter asiaticus’ infection: Microscopy and microarray analyses. Phytopathology 99:50-57.
31. Leonard et al., 2012. Complete genome sequence of Liberibacter crescens BT-1. Stand Genomic Sci 7:271-283.
32. Lin et al., 2011. The complete genome sequence of ‘Candidatus Liberibacter solanacearum’, the bacterium associated with potato zebra chip disease. PLoS One 6:e19135.
33. Livak and Schmittgen, 2001. Analysis of relative gene expression data using real-time quantitative PCR and the 2^{-ΔΔCT} method. Methods 25:402-408.
34. Lu, 2009. Dissection of salicylic acid-mediated defense signaling networks. Plant Signal. Behav. 4:713-717.
35. Lu et al., 2013. Overexpression of a citrus NDR1 ortholog increases disease resistance in Arabidopsis. Front. Plant Sci. doi: 10.3389/fpls.2013.00157.
36. Luna et al., 2014. Role of NPR1 and KYP in long-lasting induced resistance by β-aminobutyric acid. Front Plant Sci 5:184.
37. Martínez-Abarca et al., 1998. Involvement of salicylic acid in the establishment of the Rhizobium meliloti-Alfalfa symbiosis. Mol. Plant-Microbe Interact. 11:153-155.
38. Moore, 1981. Effect of hexose analogs on fungi: Mechanisms of inhibition and resistance. New Phytol. 87, 487-515.
39. Nakanishi et al., 976. Demonstration of curdlan-type polysaccharide and some other β-1,3-glucan in microorganisms with aniline blue. J. Gen. Appl. Microbiol. 22:1-11.
40. Ogawa et al., 1994. 2-Deoxy-D-Glucose inhibits intracellular multiplication and promotes intracellular killing of Legionella pneumophila in A/J mouse macrophages. Infection and Immunity 62:266-270.
41. Pagliai et al., 2014. The transcriptional activator LdtR from Candidatus Liberibacter asiaticus' mediates osmotic stress tolerance. PLoS Pathog. 10(4): e1004101. doi:10.1371/journal.ppat.1004101.
42. Pelz-Stelinski et al., 2010. Transmission parameters for Candidatus Liberibacter asiaticus by Asian citrus psyllid (Hemiptera: Psyllidae). J. Econ. Entomol. 103:1531-1541.
43. Porat et al., 2003. Induction of resistance to Penicillium digitatum in grapefruit by β-aminobutyric acid. Eur. J. Plant Pathol. 109(9):901-907.
44. Russell and Wells, 1997. The ability of 2-deoxyglucose to promote the lysis of Streptococcus bovis JB1 via a mechanism involving cell wall stability. Curr. Microbiol. 35:299-304.
45. Sánchez-Najera et al., 2013. Ascorbic acid on oral microbial growth and biofilm formation. The Pharma Innovation 2:103-109.
46. Simko and Piepho, 2012. The area under the disease progress stairs: Calculation, advantage, and application. Phytopathology 102:381-389.
47. Spoel and Dong, 2012. How do plants achieve immunity? Defence without specialized immune cells. Nature Reviews Immunology 12:89-100.
48. Stansly et al., 2014. Vector control and foliar nutrition to maintain economic sustainability of bearing citrus in Florida groves affected by huanglongbing. Pest Manag. Sci. 70: 415-426.
49. Sutton et al., 2005. Detection and identification of citrus Huanglongbing (greening) in Florida, USA. 2005. Page 59 in: Proc. Second Int. Citrus Canker Huanglongbing Res. Workshop, Orlando, Fla.
50. Tabak et al., 2003. Diverse effects of ascorbic acid and palmitoyl ascorbate on Helicobacter pylori survival and growth. FEMS Microbiol. Letters 224: 247-253.
51. Teixeira et al., 2005. Citrus huanglongbing in São Paulo State, Brazil: PCR detection of the ‘Candidatus Liberibacter’ species associated with the disease. Mol. Cell. Probes 19:173-179.
52. Tett et al., 2014. Characterisation of SalRAB a salicylic acid inducible positively regulated efflux system of Rhizobium leguminosarum bv. viciae 3841. PLoS ONE 9(8): e103647. doi:10.1371/journal.pone.0103647.
53. Tiwari et al., 2011. Insecticide resistance in field populations of Asian citrus psyllid in Florida. Pest Manag. Sci. 67:1258-1268.
54. Tiwari et al., 2013. Induced resistance against the Asian citrus psyllid, Diaphorina citri, by β-aminobutyric acid in citrus. Bulletin of Entomological Research 103:592-600.
55. Ton and Mauch-Mani, 2004. β-Amino-butyric acid-induced resistance against necrotrophic pathogens is based on ABA-dependent priming for callose. Plant J. 38:119-130.
56. Ton et al., 2005. Dissecting the β-aminobutyric acid induced priming phenomenon in Arabidopsis. Plant Cell 17:987-999.
57. Trivedi et al., 2009. Quantification of viable Candidatus Liberibacter asiaticus in hosts using quantitative PCR with the aid of ethidium monoazide (EMA). European Journal of Plant Pathology 124:553-563.
58. Vallad and Goodman, 2004. Systemic acquired resistance and induced systemic resistance in conventional agriculture. Crop Science 44:1920-1934.
59. van Loon et al., 2006. Significance of inducible defense-related proteins in infected plants. Annu. Rev. Phytopathol. 44:135-162.
60. Walters et al., 2013. Controlling crop diseases using induced resistance: challenges for the future. J. Exp. Bot. 64: 1263-1280.
61. Walters et al., 2005. Induced resistance for plant disease control: Maximizing the efficacy of resistance elicitors. Phytopathology 95:1368-1373.
62. Wang and Trivedi, 2013. Citrus Huanglongbing: an old problem with an unprecedented challenge. Phytopathology 103:652-665.
63. Wang et al., 2006. Development and application of molecular-based diagnosis for ‘Candidatus Liberibacter asiaticus’, the causal pathogen of citrus huanglongbing. Plant Pathol. 55:630-638.
64. Weller et al., 2012. Induced systemic resistance in Arabidopsis thaliana against Pseudomonas syringae pv. tomato by 2,4-diacetylphloroglucinol producing Pseudomonas fluorescens. Phytopathology 102:403-412.
65. Wick et al., 1957. Localization of the primary metabolic block produced by 2-deoxyglucose. J. Biol. Chem. 224:963-969.
66. Wulff et al., 2014. The complete genome sequence of ‘Candidatus Liberibacter americanus’, associated with Citrus huanglongbing. Mol. Plant-Microbe Interact. 27:163-176.
67. Xu et al., 2013. Preliminary research on soil conditioner mediated citrus Huanglongbing mitigation in the field in Guangdong, China. Eur. J. Plant Pathol. 137:283-293.
68. Yuan et al., 2007. The plant signal salicylic acid shuts down expression of the vir regulon and activates quorum-quenching genes in Agrobacterium. Proc. Nat. Acad. Sci. USA 10:11790-11795.
69. Zamioudis and Pieterse, 2012. Modulation of host immunity by beneficial microbes. Mol. Plant-Microbe Interact. 25:139-150.
70. Zhang et al., 2011. Chemical compounds effective against the citrus Huanglongbing bacterium ‘Candidatus Liberibacter asiaticus’ in planta. Phytopathology 101:1097-1103.
71. Zimmerli et al., 2000. Potentiation of pathogen-specific defense mechanisms in Arabidopsis by β-aminobutyric acid. Proc. Nat. Acad. Sci. USA 97:12920-12925.

What is claimed is:

1. A method of treating a plant disease in a citrus plant in need thereof comprising administering to the citrus plant a composition which comprises a botanically compatible vehicle and at least one compound selected from the group consisting of β-aminobutyric acid (BABA) or a salt thereof; and 2-deoxy-D-glucose (2-DDG) or a salt thereof.

2. The method of claim 1, wherein the compound is BABA.

3. The method of claim 2, wherein the BABA is at a concentration ranging from 15 μM to 1000 mM.

4. The method of claim 3, wherein the BABA is at a concentration of 15 μM, 50 μM, 100 μM, 150 μM, 200 μM, 500 μM, 750 μM or 1 mM.

5. (canceled)

6. The method of claim 1, wherein the compound is 2-DDG.

7. The method of claim 6, wherein the 2-DDG is at a concentration of 10 μM to 100 μM.

8. (canceled)

9. The method of claim 1, wherein the administering to the plant is by soil injection, soil drenching, or foliar spraying.

10. The method of claim 2, wherein the administering to the plant is by trunk injection.

11. A method of claim 1, wherein the plant disease is a bacterial disease or a fungal disease.

12. (canceled)

13. The method of claim 1, wherein the plant disease is HLB disease.

14. The method of claim 1, wherein the plant is infected with HLB disease or has symptoms of HLB disease.

15. The method of claim 13, wherein the plant is infected with a Candidatus Liberibacter species.

16. (canceled)

17. The method of claim 1, wherein the citrus is selected from the group consisting of Citrus maxima (Pomelo); Citrus medica (Citron); Citrus micrantha (Papeda); Citrus reticulata (Mandarin orange); Citrus trifolata (trifoliate orange); Citrus japonica (kumquat); Citrus australasica (Australian Finger Lime); Citrus australis (Australian Round lime); Citrus glauca (Australian Desert Lime); Citrus garrawayae (Mount White Lime); Citrus gracilis (Kakadu Lime or Humpty Doo Lime); Citrus inodora (Russel River Lime); Citrus warburgiana (New Guinea Wild Lime); Citrus wintersii (Brown River Finger Lime); Citrus halimii (limau kadangsa, limau kedut kera) Citrus indica (Indian wild orange); Citrus macroptera; and Citrus latipes; Citrus×aurantiifolia (Key lime); Citrus×aurantium (Bitter orange); Citrus×latifolia (Persian lime); Citrus×limon (Lemon); Citrus×limonia (Rangpur); Citrus×paradisi (Grapefruit), Citrus×sinensis (Sweet orange), Citrus×tangerina (Tangerine), Poncirus trifoliata×C. sinensis (Carrizo citrange), C. paradisi “Duncan” grapefruit×Pondirus trifoliate (Swingle citrumelo), Imperial lemon, tangelo, orangelo, tangor, kinnow, kiyomi, Minneola tangelo, oroblanco, sweet orange, ugli, Buddha's hand, citron, lemon, orange, bergamot orange, bitter orange, blood orange, calamondin, clementine, grapefruit, Meyer lemon; Rangpur; tangerine; and yuzu.

18. A method of treating a plant disease in a citrus plant in need thereof comprising administering to the citrus plant by trunk injection a composition which comprises a botanically compatible vehicle and at least one compound selected from the group consisting of β-aminobutyric acid (BABA) or a salt thereof; salicylic acid (SA) or a salt thereof; and oxalic acid (OA) or a salt thereof.

19. (canceled)

20. (canceled)

21. A method for (a) improving resistance to disease, (b) improving the ability to defend against disease, or (c) reducing disease symptoms, in a citrus plant in need thereof, comprising administering to the citrus plant a composition which comprises a botanically compatible vehicle and at least one compound selected from the group consisting of β-aminobutyric acid (BABA) or a salt thereof and 2-deoxy-D-glucose (2-DDG) or a salt thereof.

22. The method of claim 21, wherein the administering to the plant is by soil drench or soil injection.

23. The method of claim 21, wherein the administering to the plant is by foliar spraying.

24. The method of claim 13, wherein the composition optionally further comprises salicylic acid (SA) or a salt thereof or oxalic acid (OA) or a salt thereof; or a combination thereof.

25. A method of minimizing decrease in crop yield due to a plant disease in a citrus plant population, which method comprises administering to the plants of the population a composition which comprises a botanically compatible vehicle and at least one compound selected from the group consisting of β-aminobutyric acid (BABA) or a salt thereof; and 2-deoxy-D-glucose (2-DDG) or a salt thereof, wherein, optionally, the administering is by soil drench or soil injection, or administering is by foliar spraying.

26. (canceled)

27. (canceled)

28. A method for improving crop productivity and crop quality of a citrus plant, or increasing juice content and brix:acid ratio of juice of a the citrus plant, the method comprising administering to the citrus plant a composition which comprises a botanically compatible vehicle and β-aminobutyric acid (BABA) or a salt thereof.

29. (canceled)


SEQUENCE LISTING (8 sequences)

SEQ ID NO: 1 - DNA, 20 bp, Artificial Sequence
  Description of Artificial Sequence Synthetic primer
ttccactgccatcgaaactg

SEQ ID NO: 2 - DNA, 26 bp, Artificial Sequence
  Description of Artificial Sequence Synthetic primer
gtaatcttgtttaaatgagcctcttg

SEQ ID NO: 3 - DNA, 20 bp, Artificial Sequence
  Description of Artificial Sequence Synthetic primer
ttgctccatggcggtgcaga

SEQ ID NO: 4 - DNA, 20 bp, Artificial Sequence
  Description of Artificial Sequence Synthetic primer
tggctgcgggagtaaagccg

SEQ ID NO: 5 - DNA, 20 bp, Artificial Sequence
  Description of Artificial Sequence Synthetic primer
cggattagactcgttgccat

SEQ ID NO: 6 - DNA, 20 bp, Artificial Sequence
  Description of Artificial Sequence Synthetic primer
cgcgatgcaaaaagtacaga

SEQ ID NO: 7 - DNA, 22 bp, Artificial Sequence
  Description of Artificial Sequence Synthetic primer
ggaaggtcaagatcggaatcaa

SEQ ID NO: 8 - DNA, 22 bp, Artificial Sequence
  Description of Artificial Sequence Synthetic primer
cgtccctctgcaagatgactct